(19) United States
(12) Patent Application Publication
(10) Pub. No.: US 2022/0129836 A1
(43) Pub. Date: Apr. 28, 2022

(54) VISION PRODUCT INFERENCE BASED ON PACKAGE DETECT AND BRAND CLASSIFICATION WITH ACTIVE LEARNING

(71) Applicant: Rehrig Pacific Company, Los Angeles, CA (US)

(72) Inventors: Peter Douglas Jackson, Alpharetta, GA (US); Robert Lee Martin, JR., Kenosha, WI (US); Daniel James Thyer, Charlotte, NC (US); Justin Michael Brown, Coppell, TX (US)

(21) Appl. No.: 17/508,021

(22) Filed: Oct. 22, 2021

Related U.S. Application Data
(60) Provisional application No. 63/173,482, filed on Apr. 11, 2021.
(60) Provisional application No. 63/151,404, filed on Feb. 19, 2021.
(60) Provisional application No. 63/106,196, filed on Oct. 27, 2020.
(60) Provisional application No. 63/104,175, filed on Oct. 22, 2020.

(51) Int. Cl. G06Q 10/08; G06N 5/02; G06K 7/14

(52) U.S. Cl. CPC G06Q 10/087; G06K 7/1413; G06N 5/022

(57) ABSTRACT

A delivery system generates a pick sheet containing a plurality of SKUs based upon an order. A loaded pallet is imaged to identify the SKUs on the loaded pallet, which are compared to the order prior to the loaded pallet leaving the distribution center. The loaded pallet may be imaged while being wrapped with stretch wrap. At the point of delivery, the loaded pallet may be imaged again and analyzed to compare with the pick sheet.

### BACKGROUND

The delivery of products to stores from distribution centers has many steps that are subject to errors and inefficiencies. When the order from the customer is received, at least one pallet is loaded with the specified products according to a “pick list.”

For example, the products may be cases of beverage containers (e.g. cartons of cans, beverage crates containing bottles or cans, cardboard trays with plastic overwrap, etc). There are many different permutations of flavors, sizes, and types of beverage containers delivered to each store. When building pallets, missing or mis-picked product can account for significant additional operating costs.

At the store, the driver unloads the pallet(s) designated for that location. Drivers often spend a significant amount of time waiting in the store for a clerk to become available to check in the delivered product by physically counting it. During this process the clerk ensures that all product ordered is being delivered. The driver and clerk often break down the pallet and open each case to scan one UPC from every unique flavor and size. After the unique flavor and size is scanned, both the clerk and driver count the number of cases or bottles for that UPC. This continues until all product is accounted for on all the pallets. Clerks are typically busy helping their own customers which forces the driver to wait until a clerk becomes available to check-in product.

### SUMMARY

The improved delivery system provides improvements to several phases of the delivery process. Although these improvements work well when practiced together, fewer than all, or even any one of these improvements could be practiced alone to some benefit.

The improved delivery system facilitates order accuracy from the warehouse to the store via machine learning and computer vision software, optionally combined with a serialized (RFID/Barcode) shipping pallet. Pallet packing algorithms are based on the product mix and warehouse layout.

Electronic order accuracy checks are done while building pallets, loading pallets onto trailers and delivering pallets to the store. When building pallets, the delivery system validates the build to ensure the correct product SKUs are being loaded on the correct pallet according to the pick list. Once the pallet is built the overall computer vision sku count for that specific pallet is compared against the pick list for that specific pallet to ensure the pallet is built correctly. This may be done prior to the pallet being stretch wrapped thus mitigating the cost of unwrapping of the pallet to audit and correct. This also prevents shortages and overages at the delivery point thus preventing the driver from having to bring back excess or make additional trips to deliver missing product.

The system will also decrease the time for the receiver at the delivery point (e.g. store) to check-in the product through a combination of checks that build trust at the delivery point. This may be done through conveyance of the computer vision images of the validated SKUs on the pallet before it left the warehouse and upon delivery to the store. This can be a comparison of single images or a deep machine learning by having the image at the store also electronically identify the product SKUs. Delivery benefits include significantly reducing costs associated with waiting and checking product in at the store level and a verifiable electronic ledger of what was delivered for future audit.

It may be beneficial to reduce the number of SKUs in the machine learning models, particularly the brand models, by splitting the machine learning models into several different models. The system may optionally include a computer system and a computer-implemented method for creating machine learning models. The computing system includes at least one processor and at least one non-transitory computer-readable media storing instructions that, when executed by the at least one processor, cause the computer system to perform the following operations. The computer system receives SKU information including brand and package type for each of a plurality of SKUs. The computer system creates a plurality of brand nodes, a plurality of package nodes and a plurality of SKU links. Each SKU link connects one of the plurality of brand nodes to one of the plurality of package nodes. Each SKU link represents one of the plurality of SKUs having the associated brand and the associated package. Each of the plurality of brand nodes in a first subset of the plurality of brand nodes is connected by a first subset of the plurality of SKU links to more than one of the plurality of package nodes. Each of the plurality of package nodes in a second subset of the plurality of package nodes is connected by a second subset of the plurality of SKU links to more than one of the plurality of brand nodes.

Using this method, the computer system determines a cut line to divide the plurality of SKU links into a first machine learning model and a second machine learning model. This step is performed based upon reducing a number of SKU links intersected by the cut line and based upon a tendency toward an equal number of SKU links in each machine learning model defined by the cut line. The computer system duplicates the SKU links intersected by the cut line in the first machine learning model and in the second machine learning model. The computer system duplicates the brand nodes and the package nodes directly connected by the SKU links intersected by the cut line in the first machine learning model and the second machine learning model.

The computing system may train the first machine learning model with a plurality of images of the plurality of SKUs represented by the SKU links in the first machine learning model. The second machine learning model is trained with a plurality of images of the plurality of SKUs represented by the SKU links in the second machine learning model.

The computing system may determine a second cut line to further divide the plurality of SKU links into a third machine learning model. In this example, it may be that the second cut line does not intersect any SKU links. The third machine learning model may be trained with a plurality of images of the plurality of SKUs represented by the SKU links in the third machine learning model.

The brand nodes may each represent a flavor of a beverage and wherein the package nodes may each represent a package type containing the beverage.

The flavors represented by the brand nodes may include flavors of soft drinks and the package type represented by the package nodes may include a first package type in which a certain number of cans are contained in a box.

A computing system for identifying SKUs in a stack of a plurality of packages of beverage containers includes at least one processor and at least one non-transitory computer-readable media storing a plurality of machine learning models that have been trained with a plurality of images of packages of beverage containers. The computer-readable media also stores instructions that, when executed by the at least one processor, cause the computer system to perform the following operations. The computer system receives at least one image of the stack of the plurality of packages of beverage containers. The computer system infers a package type of each of the plurality of packages of beverage containers. Based upon the package type inferred for each of the plurality of packages of beverage containers, the computer system chooses at least one of the plurality of machine learning models. The computer system, using the chosen machine learning model, for each of the plurality of packages of beverage containers, infers a brand of each of the plurality of packages of beverage containers based upon the at least one image.

The computing system may further identify at least one inferred SKU for each of the plurality of packages of beverage containers based upon the inferred package type inferred and the inferred brand inferred.

The computing system may further compare the at least one inferred SKUs for each of the plurality of packages of beverage containers with a pick list representing a plurality of expected SKUs in an order.

The computing system may further identify an extra inferred SKU and identify a missing expected SKU. It is determined whether the extra inferred SKU and the missing expected SKU are associated with one another in a SKU set. Based upon a determination that the extra inferred SKU and the missing expected SKU are associated with one another in a SKU set, the computer system substitutes the expected SKU for the inferred SKU or otherwise ignores discrepancies associated with the extra inferred SKU and the missing expected SKU. It is determined that there is not an error, but may be labeled as “cannot confirm” and/or “not vision verified.”

The at least one image may include a plurality of images from different sides of the stack of packages of beverage containers. The computer system may further associate portions of each of the plurality of images with one another corresponding to the same ones of the plurality of packages of beverage containers.

The computing system may perform the operations of inferring package type, choosing a machine learning brand model based upon the inferred package type, and then using the chosen machine learning brand model for each of the portions of each of the plurality of images.

The computing system may generate a confidence level for the package type inferred for each of the portions of each of the plurality of images.

The computing system may generate a confidence level for the brand inferred for each of the portions of each of the plurality of images.

### BRIEF DESCRIPTION OF THE DRAWINGS

FIG. 1 is a schematic view of a delivery system.

FIGS. 2 is a flowchart of one version of a method for delivering items.

FIG. 3 shows an example loading station of the delivery system of FIG. 1.

FIG. 4 shows an example validation station of the delivery system of FIG. 1.

FIG. 5 is another view of the example validation system of FIG. 4 with a loaded pallet thereon.

FIG. 6 shows yet another example validation system of the delivery system of FIG. 1.

FIG. 7 shows portions of a plurality of machine learning models.

FIG. 8 is a flowchart showing a method for creating the machine learning models of FIG. 7.

FIG. 9 shows sample text descriptions of a plurality of sample SKUs, including how SKUs are identified by both package type and brand.

FIG. 10 is a flowchart of a sku identification method.

FIG. 11 illustrates the step of detecting the package faces on each side of the stack of items.

FIG. 12 illustrates four pallet faces of a loaded pallet.

FIG. 12A shows stitching all package faces together for one of the packages from the pallet faces in FIG. 12.

FIG. 12B shows stitching all package faces together for another one of the packages from the pallet faces in FIG. 12.

FIG. 12C shows stitching all package faces together for another one of the packages from the pallet faces in FIG. 12.

FIG. 12D shows stitching all package faces together for another one of the packages from the pallet faces in FIG. 12.

FIGS. 13 and 14 illustrate the step of selecting the best package type from the stitched package faces.

FIG. 15 shows an example of a plurality stitched images and selecting the best brand from among the plurality of stitched images.

FIG. 16 shows a flowchart for a SKU set heuristic.

FIG. 17 shows a flowchart for a low confidence brand heuristic.

FIG. 18 shows a flowchart for an unverifiable SKU heuristic.

FIG. 19 shows a flowchart for an unverifiable quantity heuristic.

FIG. 20 illustrates an example implementing the unverifiable quantity heuristic of FIG. 19.

FIG. 21 illustrates an example of multiple face view override.

FIG. 22 shows a flowchart for the override multiple face view heuristic.

FIG. 23 shows an example of portions of images incorrectly stitched together.

FIG. 24 shows an example of the single face view heuristic.

FIG. 25 is a flowchart for the single face view heuristic.

FIG. 26 is a flowchart for the weight checksum.

FIG. 27 is a flowchart for the weight heuristic.

FIG. 28 demonstrates a sample screen of the supervised labeling tool for fixing errors.

FIG. 29 also shows another sample screen of the supervised labeling tool.

FIG. 30 shows an example training station of the delivery system of FIG. 1.

FIG. 31 shows one possible architecture of the training feature of the system of FIG. 1.

FIG. 32 is a flowchart of one version of a method for training a machine learning model.

FIG. 33 shows an example screen indicating a mis-picked loaded pallet at the distribution center.

FIG. 34 shows an example screen indicating a validated loaded pallet at the distribution center.

### DETAILED DESCRIPTION

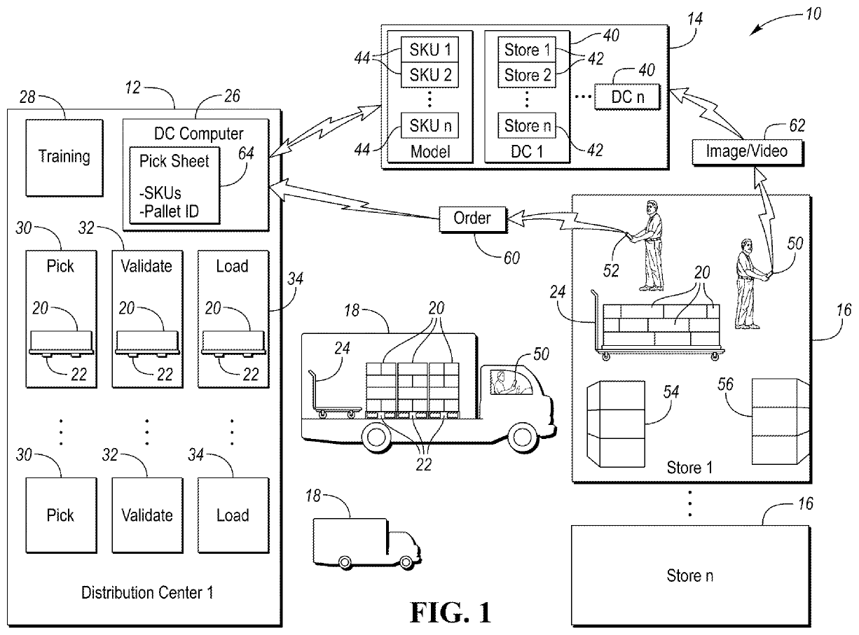

FIG. 1 is a high-level view of a delivery system 10 including one or more distribution centers 12, a central server 14 (e.g. cloud computer), and a plurality of stores 16. A plurality of trucks 18 or other delivery vehicles each transport the products 20 on pallets 22 from one of the distribution centers 12 to a plurality of stores 16. Each truck 18 carries a plurality of pallets 22 which may be half pallets (or full-size pallets), each loaded with a plurality of goods 20 for delivery to one of the stores 16. A wheeled sled 24 is on each truck 18 to facilitate delivery of one of more pallets 22 of goods 20 to each store 16. Generally, the goods 20 could be loaded on the half pallets, full-size pallets, carts, or hand carts, or dollies -all considered “platforms” herein.

Each distribution center 12 includes one or more pick stations 30, a plurality of validation stations 32, and a plurality of loading stations 34. Each loading station 34 may be a loading dock for loading the trucks 18.

Each distribution center 12 may include a DC computer 26. The DC computer 26 receives orders 60 from the stores 16 and communicates with a central server 14. Each DC computer 26 receives orders and generates pick sheets 64, each of which stores SKUs and associates them with pallet ids. Alternatively, the orders 60 can be sent from the DC computer 26 to the central server 14 for generation of the pick sheets 64, which are synced back to the DC computer 26.

Some or all of the distribution centers 12 may include a training station 28 for generating image information and other information about new products 20 which can be transmitted to the central server 14 for analysis and future use.

The central server 14 may include a plurality of distribution center accounts 40, including DC1-DCn, each associated with a distribution center 12. Each DC account 40 includes a plurality of store accounts 42, including store 1-store n. The orders 60 and pick sheets 64 for each store are associated the associated store account 42. The central server 14 further includes a plurality of machine learning models 44 trained as will be described herein based upon SKUs. The models 44 may be periodically synced to the DC computers 26 or may be operated on the server 14.

The machine learning models 44 are used to identify SKUs. A “SKU” may be a single variation of a product that is available from the distribution center 12 and can be delivered to one of the stores 16. For example, each SKU may be associated with a particular package type, e.g. the number of containers (e.g. 12 pack) in a particular form (e.g. can v bottle) and of a particular size (e.g. 24 ounces) optionally with a particular secondary container (cardboard vs reusuable plastic crate, cardboard tray with plastic overwrap, etc). In other words, the package type may include both primary packaging (can, bottle, etc, in direct contact with the beverage or other product) and any secondary packaging (crate, tray, cardboard box, etc, containing a plurality of primary packaging containers).

Each SKU may also be associated with a particular “brand” (e.g. the manufacturer and the specific variation, e.g. flavor). The “brand” may also be considered the specific content of the primary package and secondary package (if any) for which there is a package type. This information is stored by the server 14 and associated with the SKU along with the name of the product, a description of the product, dimensions of the product, and optionally the weight of the product. This SKU information is associated with image information for that SKU in the machine learning models 44.

It is also possible that more than one variation of a product may share a single SKU, such as where only the packaging, aesthetics, and outward appearance of the product varies, but the content and quantity/size is the same. For example, sometimes promotional packaging may be utilized, which would have different image information for a particular SKU, but it is the same beverage in the same primary packaging with secondary packaging having different colors, text, and/or images. Alternatively, the primary packaging may also be different (but may not be visible, depending on the secondary packaging). In general, all the machine learning models 44 may be generated based upon image information generated through the training module 28.

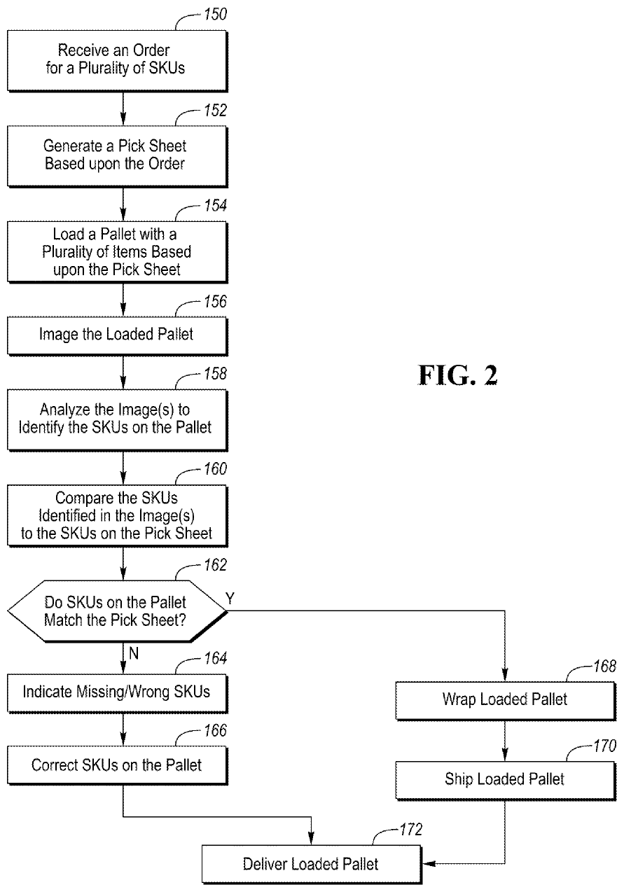

Referring to FIG. 1 and also to the flowchart in FIG. 2, an order 60 may be received from a store 16 in step 150. As an example, an order 60 may be placed by a store employee using an app or mobile device 52. The order 60 is sent to the distribution center computer 26 (or alternatively to the server 14, and then relayed to the proper (e.g. closest) distribution center computer 26). The distribution center computer 26 analyzes the order 60 and creates a pick sheet 64 associated with that order 60 in step 152. The pick sheet 64 assigns each of the SKUs (including the quantity of each SKU) from the order. The pick sheet 64 specifies how many pallets 22 will be necessary for that order (as determined by the DC computer 26). The DC computer 26 may also determine which SKUs should be loaded near one another on the same pallet 22, or if more than one pallet 22 will be required, which SKUs should be loaded together on the same pallet 22. For example, SKUs that go in the cooler may be together on the same pallet (or near one another on the same pallet), while SKUs that go on the shelf may be on another part of the pallet (or on another pallet, if there is more than one). If the pick sheet 64 is created on the DC computer 26, it is copied to the server 14. If it is created on the server 14, it is copied to the DC computer 26.

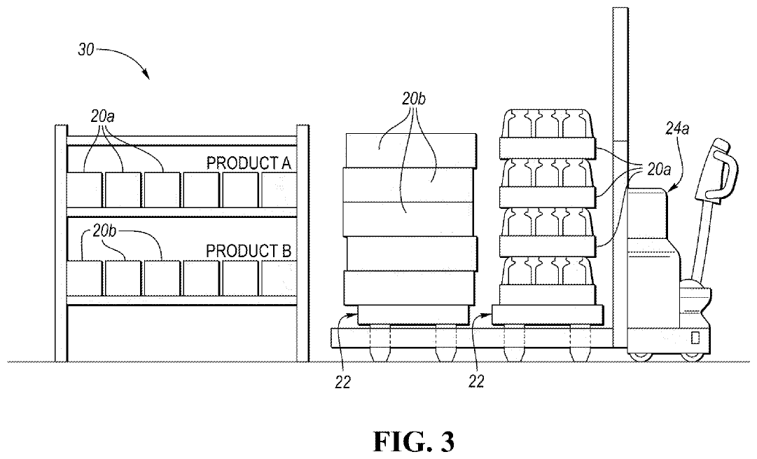

FIG. 3 shows the pick station 30 of FIG. 1. Referring to FIGS. 1 and 3, workers at the distribution center read the palled id (e.g. via rfid, barcode, etc) on the pallet(s) 22 on a pallet jack 24a, such as with a mobile device or a reader on the pallet jack 24a. In FIG. 3, two pallets 22 are on a single pallet jack 24a. Shelves may contain a variety of items 20 for each SKU, such as first product 20a of a first SKU and a second product 20b of a second SKU (collectively “products 20”). A worker reading a computer screen or mobile device screen displaying from the pick sheet 64 retrieves each product 20 and places that product 20 on the pallet 22. Alternatively, the pallet 22 may be loaded by automated handling equipment.

Workers place items 20 on the pallets 22 according to the pick sheets 64, and report the palled ids to the DC computer 26 in step 154 (FIG. 2). The DC computer 26 dictates merchandizing groups and sub groups for loading items 20a, b on the pallets 22 in order to make unloading easier at the store. In the example shown, the pick sheets 64 dictate that products 20a are on one pallet 22 while products 20b are on another pallet 22. For example, cooler items should be grouped, and dry items should be grouped. Splitting of package groups is also minimized to make unloading easer. This makes pallets 22 more stable too.

The DC computer 26 records the pallet ids of the pallet(s) 22 that have been loaded with particular SKUs for each pick sheet 64. The pick sheet 64 may associate each pallet id with each SKU.

After being loaded, each loaded pallet 22 is validated at the validation station 32, which may be adjacent to or part of the pick station 30. As will be described in more detail below, at least one still image, and preferably several still images or video, of the products 20 on the pallet 22 is taken at the validation station 32 in step 156 (FIG. 2). The pallet id of the pallet 22 is also read. The images are analyzed to determine the SKUS of the products 20 that are currently on the identified pallet 22 in step 158. The SKUs of the products 20 on the pallet 22 are compared to the pick sheet 64 by the DC computer 26 in step 160, to ensure that all the SKUs associated with the pallet id of the pallet 22 on the pick sheet 64 are present on the correct pallet 22, and that no additional SKUs are present. Several ways are of performing the aforementioned steps are disclosed below.

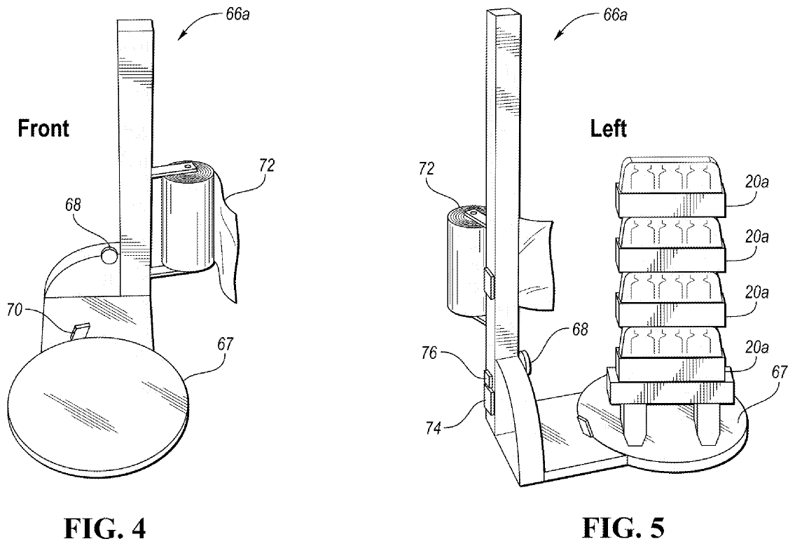

First, referring to FIGS. 4 and 5, the validation station may include a CV/RFID semi-automated wrapper 66a with turntable 67 that is fitted with a camera 68 and rfid reader 70 (and/or barcode reader). The wrapper 66a holds a roll of translucent, flexible, plastic wrap or stretch wrap 72. As is known, a loaded pallet 22 can be placed on the turntable 67, which rotates the loaded pallet 22 as stretch wrap 72 is applied. The camera 68 may be a depth camera. In this wrapper 66a, the camera 68 takes at least one image of the loaded pallet 22 while the turntable 67 is rotating the loaded pallet 22, prior to or while wrapping the stretch wrap 72 around the loaded pallet 22. Images/video of the loaded pallet 22 after wrapping may also be generated. As used herein, “image” or “images” refers broadly to any combination of still images and/or video, and “imaging” means capturing any combination of still images and/or video. Again, preferably 2 to 4 still images, or video, are taken. Most preferably, one still image of each of the four sides of a loaded pallet 22 is taken.

In one implementation, the camera 68 may be continuously determining depth while the turntable 67 is rotating. When the camera 68 detects that the two outer ends of the pallet 22 are equidistant (or otherwise that the side of the pallet 22 facing the camera 68 is perpendicular to the camera 68 view), the camera 68 records a still image. The camera 68 can record four still images in this manner, one of each side of the pallet 22.

The rfid reader 70 (or barcode reader, or the like) reads the pallet id (a unique serial number) from the pallet 22. The wrapper 66a includes a local computer 74 in communication with the camera 68 and rfid reader 70. The computer 74 can communicate with the DC computer 26 (and/or server 14) via a wireless network card 76. The image(s) and the pallet id are sent to the server 14 via the network card 76 and associated with the pick list 64 (FIG. 1). Optionally, a weight sensor can be added to the turntable 67 and the known total weight of the products 20 and pallet 22 can be compared to the measured weight on the turntable 67 for confirmation. An alert is generated if the total weight on the turntable 67 does not match the expected weight (i.e. the total weight of the pallet plus the known weights for the SKUs for that pallet id on the pick sheet). Other examples using the weight sensor are provided below.

As an alternative, the turntable 67, camera 68, rfid reader 70, and computer 74 of FIGS. 3 and 4 can be used without the wrapper. The loaded pallet 22 can be placed on the turntable 67 for validation only and can be subsequently wrapped either manually or at another station.

Alternatively, the validation station can include the camera 68 and rfid reader 70 (or barcode reader, or the like) mounted to a robo wrapper (not shown). As is known, instead of holding the stretch wrap 72 stationary and rotating the pallet 22, the robo wrapper travels around the loaded pallet 22 with the stretch wrap 72 to wrap the loaded pallet 22. The robo wrapper carries the camera, 68, rfid reader 70, computer 74 and wireless network card 76.

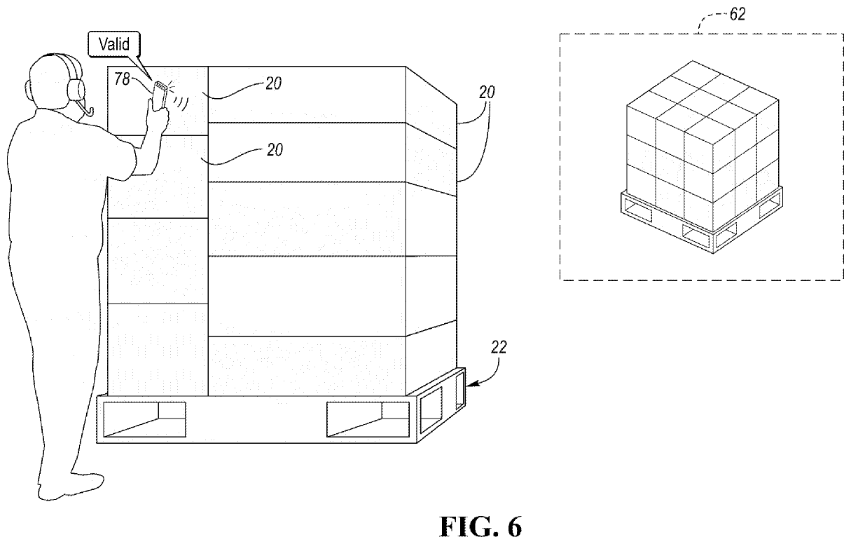

Alternatively, referring to FIG. 6, the validation station can include a worker with a networked camera, such as on a mobile device 78 (e.g. smartphone or tablet) for taking one or more images 62 of the loaded pallet 22, prior to wrapping the loaded pallet 22. Again, preferably, one image of each face of the loaded pallet 22 is taken. Note that FIG. 6 shows a full-size pallet (e.g. 40×48 inches). Any imaging method can be used with any pallet size, but a full-size pallet is shown in FIG. 6 to emphasize that the inventions herein can also be used with full-size pallets, although with some modifications.

Other ways can be used to gather images of the loaded pallet. In any of the methods, the image analysis and/or comparison to the pick list is performed on the DC computer 26, which has a copy of the machine learning models. Alternatively, the analysis and comparison can be done on the server 14, locally on a computer 74, or on the mobile device 78, or on another locally networked computer.

As mentioned above, the camera 68 (or the camera on the mobile device 78) can be a depth camera, i.e. it also provides distance information correlated to the image (e.g. pixel-by-pixel distance information or distance information for regions of pixels). Depth cameras are known and utilize various technologies such as stereo vision (i.e. two cameras) or more than two cameras, time-of-flight, or lasers, etc. If a depth camera is used, then the edges of the products stacked on the pallet 22 are easily detected (i.e. the edges of the entire stack and possibly edges of individual adjacent products either by detecting a slight gap or difference in adjacent angled surfaces). Also, the depth camera 68 can more easily detect when the loaded pallet 22 is presenting a perpendicular face to the view of the camera 68 for a still image to be taken.

However the image(s) of the loaded pallet 22 are collected, the image(s) are then analyzed to determine the sku of every item 20 on the pallet 22 in step 158 (FIG. 2). Image information, weight and dimensions of all sides of every possible product, including multiple versions of each SKU, if applicable, are stored in the server 14. If multiple still images or video are collected, then the known dimensions of the pallet 22 and the items 20 are used to ensure that every item 20 is counted once and only once. For example, the multiple sides of the loaded pallet 22 may be identified in the images first. Then, the layers of items 20 are identified on each side. The individual items 20 are then identified on each of the four sides of the loaded pallet 22.

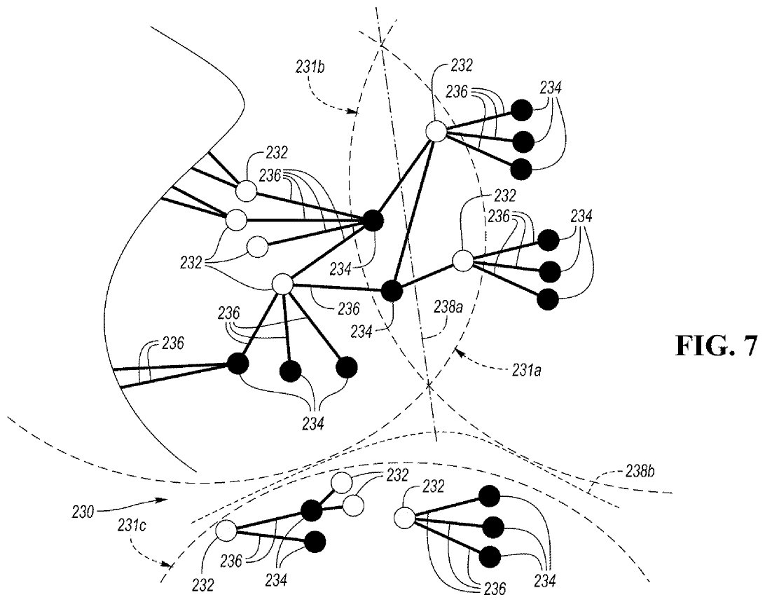

FIG. 7 shows a portion of a brand model map 230 containing the machine learning models for the brand identification, in this example brand models 231a, 231b, 231c. In FIG. 7, each white node is a brand node 232 that represents a particular brand and each black node is a package node 234 that represents a package type. Each edge or link 236 connects a brand node 232 to a package node 234, such that each link 236 represents a SKU. Each brand node 232 may be connected to one or more package nodes 234 and each package node 234 may connect to one or more brand nodes 232.

In practice, there may be hundreds or thousands of such SKUs and there would likely be two to five models 231. If there are even more SKUs, there could be more models 231. FIG. 7 is a simplified representation showing only a portion of each brand model 231a, 231b, 231c. Each model may have dozens or even hundreds of SKUs.

Within each of models 231a and 231b, all of the brand nodes 232 and package nodes 234 are connected in the graph, but this is not required. In fact, there may be one or more (four are shown) SKUs that are in both models 231a and 231b. There is a cut-line 238a separating the two models 231a and 231b. The cut-line 238a is positioned so that it cuts through as few SKUs as possible but also with an aim toward having a generally equal or similar number of SKUs in each model 231. Each brand node 232 and each package node 234 of the SKUs along the cut-line 238a are duplicated in both adjacent models 231a and 231b. For the separation of model 231c from models 231a and 231b, it was not necessary for the cut line 238b to pass through (or duplicate) any of the SKUs or nodes 232, 234.

In this manner, the models 231a and 231b both learn from the SKUs along the cut 238b. The model 231b learns more about the brand nodes 232 in the overlapping region because it also learns from those SKUs. The model 231a learns more about the package types 234 in the overlapping region because it also learns from those SKUs. If those SKUs were only placed in one of the models 231a, 231b, then the other model would not have as many samples from which to learn.

In brand model 231c, for example, as shown, there are a plurality of groupings of SKUs that do not connect to other SKUs, i.e. they do not share either a brand or a package type. The model 231c may have many (dozens or more) of such non-interconnected groupings of SKUs. The model 231a and the model 231b may also have some non-interconnected groupings of SKUs (not shown).

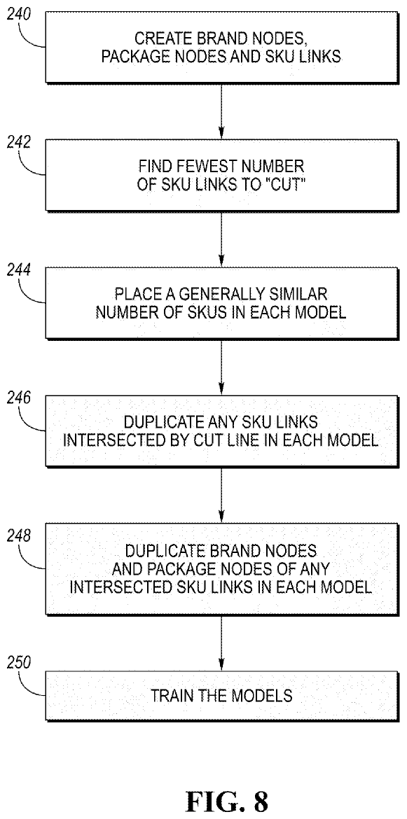

Referring to FIGS. 7 and 8, the process for creating the models 231 is automated and performed in the central server 14 or the DC computer 26 (FIG. 1). In particular, this is the process for creating the brand models. There would be one model for determining package type and then depending on how many brands there are, the SKUs are separated into multiple separate machine learning models for the brands.

This process is performed initially when creating the machine learning models and again when new SKUs are added. Initially, a target number of SKUs per model or a target number of models may be chosen to determine a target model size. Then the largest subgraph (i.e. a subset of SKUs that are all interconnected) is compared to the target model size. If the largest subgraph is within a threshold of the target model size, then no cuts need to be made. If the largest subgraph is more than a threshold larger than the target model size, then the largest subgraph will be cut according to the following method. In step 240, the brand nodes 232, package nodes 234, and SKU links 236 are created. In steps 242 and 244, the cut line 238 is determined as the fewest numbers of SKU links 236 to cut (cross), while placing a generally similar number of SKUs in each model 231. The balance between these two factors may be adjusted by a user, depending on the total number of SKUs, for example. In step 246, any SKU links 236 intersected by the “cut” are duplicated in each model 231. In step 248, the brand nodes 232 and package nodes 234 connected to any intersected SKU links 236 are also duplicated in each model 231. In step 250, the models 231 a, b, c are then trained according to one of the methods described herein, such as with actual photos of the SKUs and/or with the virtual pallets.

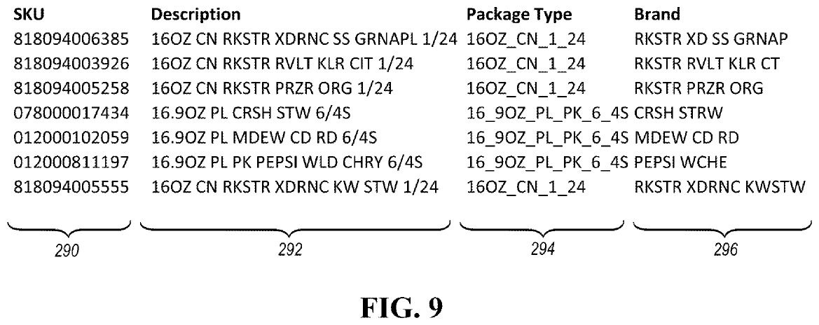

Referring to FIG. 9, each SKU 290 is also associated with a text description 292, a package type 294 and a brand 296. Each package type 294 corresponds to one of the package nodes 234 of FIG. 7, and each brand 296 corresponds to one of the brand nodes 232 of FIG. 7. Therefore, again, each package type 294 may be associated with more than one brand 296, and each brand 296 may be available in more than one package type 294. The package type 294 describes the packaging of the SKU 290. For example 16 OZ_CN_1_24 is a package type 294 to describe sixteen ounce cans with twenty-four grouped together in one case. A case represents the sellable unit that a store can purchase from the manufacturer. The brand 296 is the flavor of the beverage and is marketed separately for each flavor. For example, Pepsi, Pepsi Wild Cherry and Mountain Dew are all “brands.” Each flavor of Gatorade is a different “brand.”

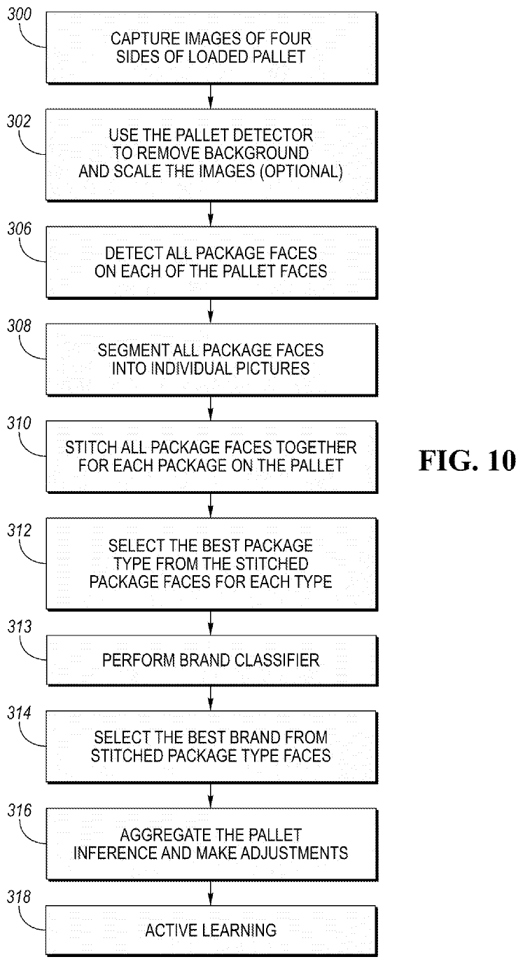

FIG. 10 shows an example of one method for identifying skus on the loaded pallet 22. In step 300, images of four sides of the loaded pallet 22 are captured according to any method, such as those described above.

FIG. 10 depicts optional step 302, in which the pallet detector module is used to remove the background and to scale the images. The pallet detector uses a machine learning object detector model that detects all of the products on the pallet 22 as a single object. The model is trained using the same virtual pallets and real pallet images that also used for the package detector but labeled differently. The pallet detector is run against each of the four images of the pallet faces. The background is blacked out so that product not on the pallet 22 is hidden from the package detector inference run later. This prevents mistakenly including skus that are not on the pallet. The left and right pallet faces are closer to the camera than the front and back faces. This causes the packages on the left and right face to look bigger than the packages on the front and back faces. The pallet detector centers and scales the images so that the maximum amount of product is fed to the pallet detector model. Again this step of blacking out the background and scaling the images is optional.

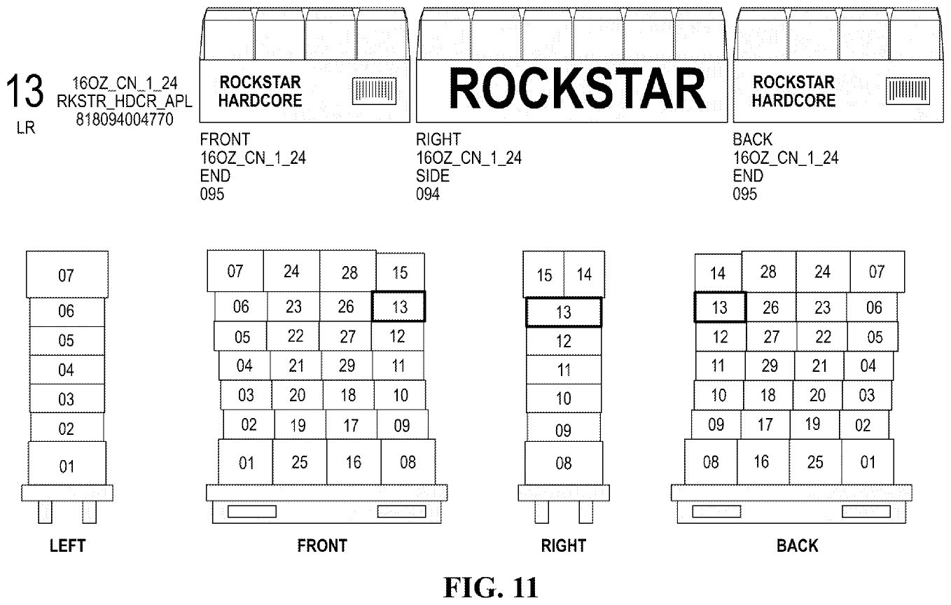

Referring to FIGS. 10 and 11, in step 306, a machine learning object detector detects all the package faces on the four pallet faces. The package type is independent from the brand. Package types are rectangular in shape. The long sides are called “SIDE” package faces and the short sides are called “END” package faces. In step 308, all package faces are segmented into individual pictures as shown in FIG. 11, so that the brand can be classified separately from package type. This is repeated for all four pallet faces.

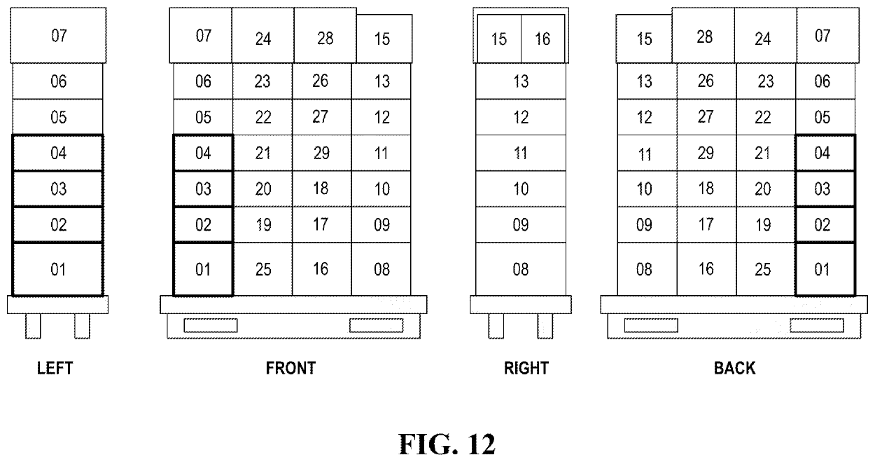

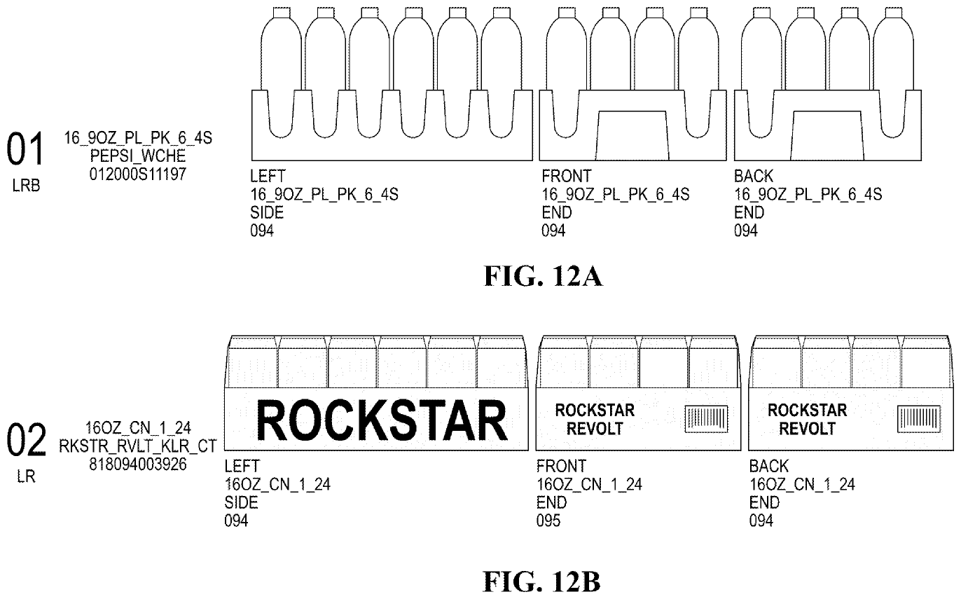

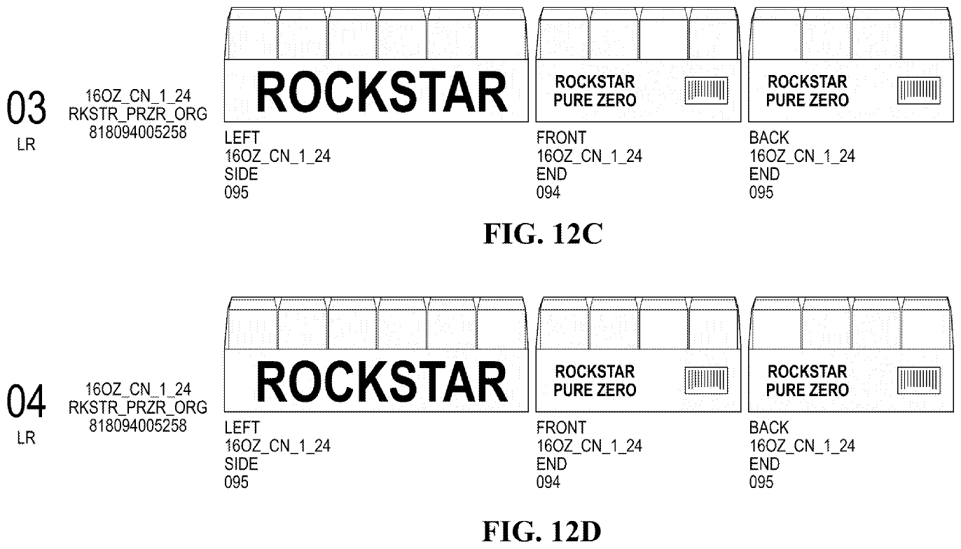

Referring to FIGS. 10 and 12, in step 310, it is determined which package face images belong to the same package through stitching. In this sense, “stitching” means that the images of the same item are associated with one another and with a particular item location on the pallet. Some packages are only visible on one pallet face and only have one image. Packages may have zero to four package faces visible. Packages that are visible on all four pallet faces will have four package face images stitched together. In FIG. 12, the package faces that correspond to the same package are numbered the same.

FIG. 12A shows the three package faces for product 01 from FIG. 12. FIG. 12B shows the three package faces for product 02 from FIG. 12. FIG. 12C shows the three package faces for produce 03 from FIG. 12. FIG. 12D shows the three package faces for product 04 from FIG. 12.

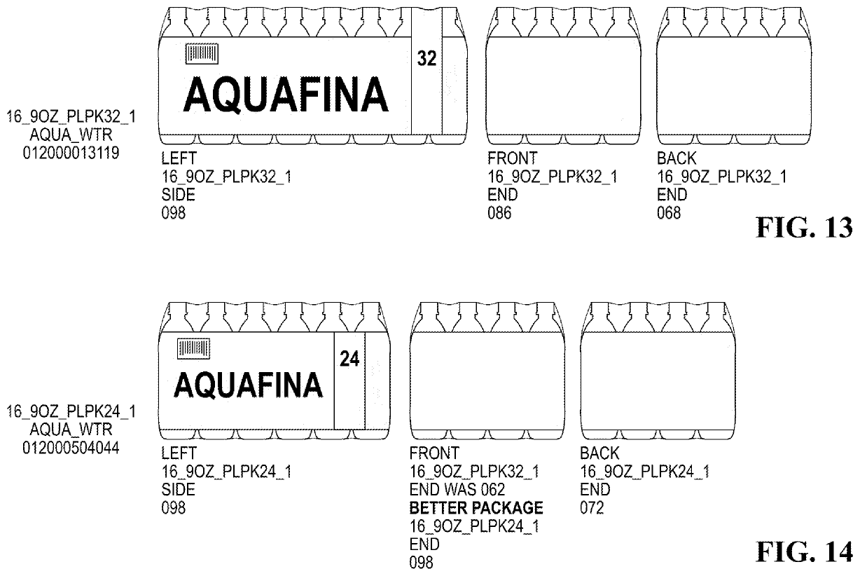

Referring to FIGS. 10, 13, and 14 in step 312, the package type of each product is inferred for each of the (up to four) possible package faces, using a machine learning model for determining package type. The package type machine learning model infers at least one package type based upon each package face independently and generates an associated confidence level for that determined package type for that package face. The package type machine learning module may infer a plurality of package types (e.g. five to twenty) based upon each package face with a corresponding confidence level associated with each such inferred package type. In FIGS. 13 and 14, only the highest-confidence package type for each package face is shown.

For each item (i.e. the images stitched together), the package face(s) with lower confident package types are overridden with the highest confident package type out of the package face images for that item. The package type with the highest confidence out of all the package face images for that item is used to override any different package type of the rest of the package faces for that same item.

For the two examples shown in FIGS. 13 and 14, the package face end views may look the same for two SKUs so it is very hard to distinguish the package type from the end views; however, the package face side view is longer for the 32 pack than the 24 pack plus the respective 32 and 24 count is visible on the package and the machine learning module can easily distinguish the difference on the side view between the 24 and 32 pack from the long side view. For example in FIG. 14, the package end face view with a confidence of 62% was overridden by a higher confidence side view image of 98% to give a better package type accuracy. Other package types include reusable beverage crate with certain bottle sizes or can sizes, corrugated tray with translucent plastic wrap a certain bottle or can sizes, or fully enclosed cardboard or paperboard box. Again, “package type” may include a combination of the primary and secondary packaging.

In step 313 of FIG. 10, for each package face, a brand model (e.g. brand models 231a, b, or c of FIG. 7) is loaded based upon the package type that was determined in step 312 (i.e. after the lower-confidence package types have been overridden). Some brands are only in their own package types. For example, Gatorade is sold in around a dozen package types but those package types are unique to Gatorade and other Pepsi products are not packaged that way. If it is determined that the package faces of a package have a Gatorade package type then those images are classified using the Gatorade brand model (for example, brand model 231c of FIG. 7). Currently, the brand model for Gatorade contains over forty flavors that can be classified. It is much more accurate to classify a brand from forty brands than to classify a brand from many hundreds or more than a thousand of brands, which is why the possibilities are first limited by the inferred package type.

The machine learning model (e.g. models 231a, b, or c of FIG. 7) that has been loaded based upon package type infers a brand independently for each package face of the item and associates a confidence level with that inferred brand for each package face. Initially, at least, higher-confidence inferred brands are used to override lower-confidence inferred brands of other package faces for the same item.

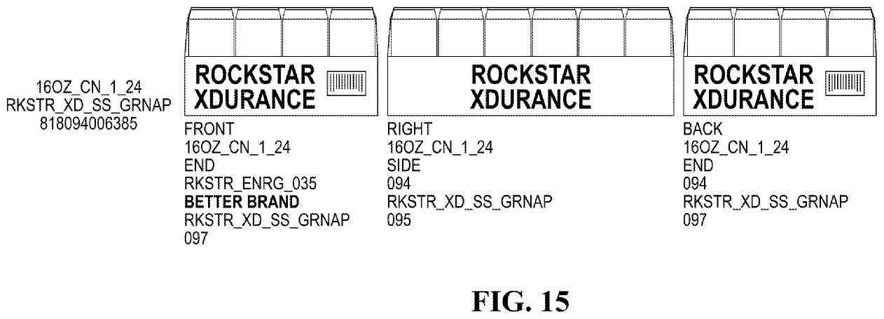

Referring to FIG. 15, one example was stitched to have the 16 OZ_CN_1_24 package type. The package was visible on three package faces. Based upon the package type model, the inference constantly agreed on this package type on all three faces. The best machine learning model 231a, b or c for brand was loaded based on the package type. If stitching would have overridden a package type for one or more package faces, then the same brand model 231a, b or c would still be used for all of the segmented images based upon the best package type out of all of the segmented images.

The example shown in FIG. 15 shows that the machine learning algorithm first classified the front image to be RKSTR_ENRG with a low 35% confidence. Fortunately, the back image had a 97% confidence of the real brand of RKSTR_XD_SS_GRNAP and the brand on the front image was overridden. At least initially, and except as otherwise described below, the best brand (i.e. highest confidence brand) from all of the stitched package images is used to determine the brand for that item. Having determined all of the package types and then the brands for each item on the pallet, the SKU for each item is determined in step 314 (FIG. 10).

It should be noted that some product is sold to stores in groups of loose packages. All of the packages are counted and divided by the number of packages sold in a case to get the inferred case quantity. The case quantity is the quantity that stores are used to dealing with on orders.

The pick list that has the expected results is then leveraged to the actual inferred results. There should be high confidence that there is an error before reporting the error so there are not too many false errors. There are several example algorithms disclosed herein that leverage the known results of the pick list to make corrections so that too many false errors are not reported: 1) Override Multiple Face View; 2) Indistinguishable SKU sets; 3) Low confident brand override; 4) Unverifiable Package Type Set; 5) Unverifiable SKU; 6) Override Single Face View; 7) SKU with unverifiable quantity; 8) Multiple Face View Count Both Products. The aforementioned sequence is preferred for a particular constructed embodiment. The sequence of the algorithms flow may be important because they consume the extra and/or missing SKU from the errors such that that extra and/or missing SKU will not be available down the flow for another algorithm.

### 1) Override Multiple Face View Heuristic

The stitching algorithms associate all the visible faces of the same package. Sometimes one of the less confident faces of the package or the brand is the correct one. The system leverages the picklist expected SKUs and make corrections if the most confident face was not on the picklist, but a lesser confident face was.

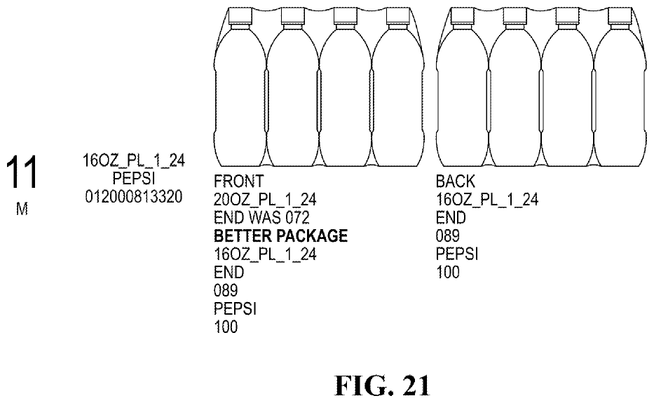

For the following example in FIG. 21, the package face with the highest confidence predicted that the image was 16 oz Pepsi, but the pick list had 20 oz Pepsi and not 16 oz. The system makes a correction to the missing 20 oz Pepsi with the extra 16 oz Pepsi found in the multi face view because: the lower confidence package face matched the pick list, the higher confidence package face did not match the pick list, and there was no other image on the pallet that matched the missing SKU (i.e. the 20 oz Pepsi). The system also allows similar corrections for brand, when a less confident brand is classified in a different package face view from the highest confident one.

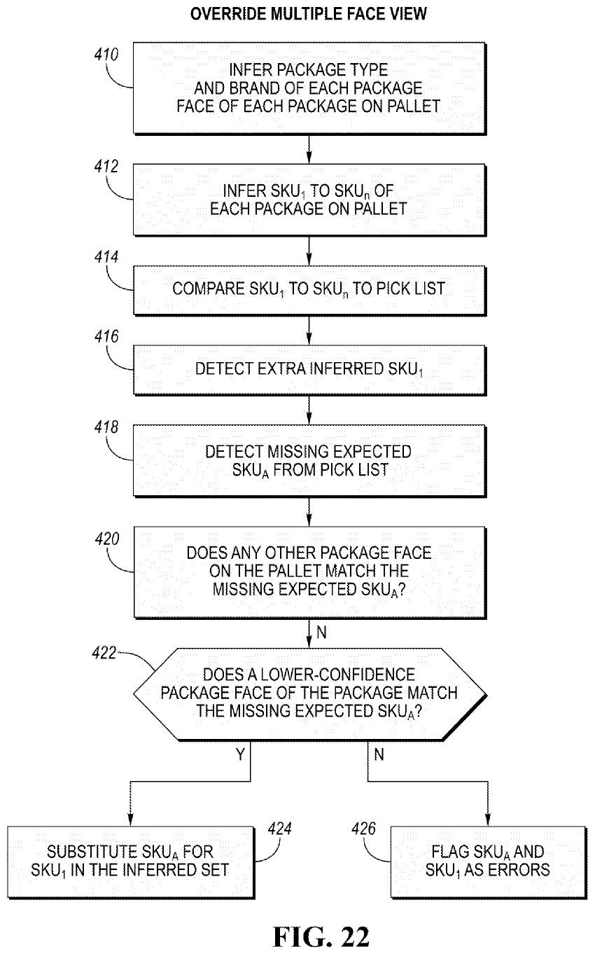

Referring to the flow chart of FIG. 22, in step 410, the package type and brand of each package face of each package are inferred according to any method herein. In step 412, SKUs for every package on the pallet are inferred (again according to methods described herein). In step 414, the inferred SKUs are compared to the expected SKUs on the pick list. In step 416, an extra SKU₁ is inferred. In step 418, a missing expected SKU_{A} is detected.

In step 420, it is determined whether any other package face on the pallet matches the missing expected SKU_{A}. If not, in step 422, it is determined if a lower-confidence package face of the package (the package previously determined to be an extra SKU₁) matches the missing expected SKU_{A}. If so, then the lower-confidence package face (same as the missing expected SKU_{A}) is used to override the SKU₁ in the inferred SKU set in step 424. If not, then SKU_{A} and SKU₁ are both flagged as errors in step 426.

Optionally, steps 420 to 424 are only performed if the confidence in the extra inferred SKU₁, although the highest-confidence face of that package, is below a threshold. If not, the errors are generated in step 426.

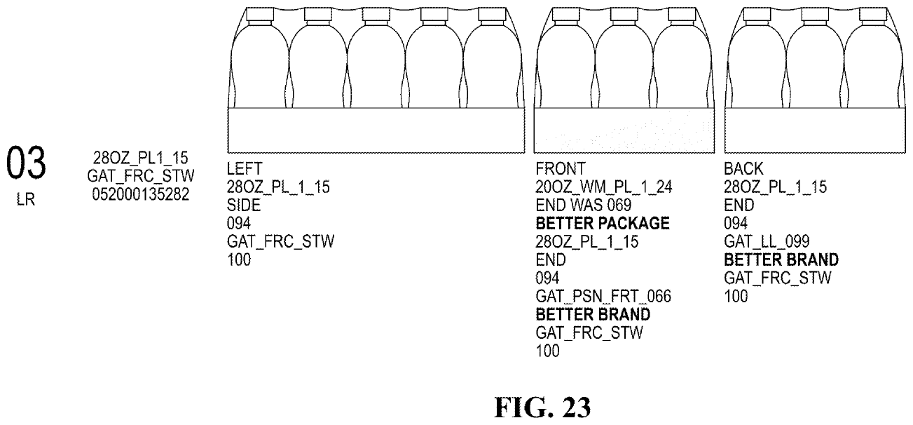

The multiple face view algorithm of FIG. 22 is also leveraged to correct stitching errors. The image in the example in FIG. 23 shows two products that were incorrectly stitched together. Errors like this can occur when the machine learning does not detect the presence of a product (a “hole”) on the pallet, causing the algorithm to stitch together package face images from different items. Even with stitching errors, the case count is often correctly inferred. The multiple face view algorithm can make heuristic corrections to compensate for the stitching errors when the correct case count is still inferred.

FIG. 23 shows two different packages incorrectly stitched together. Both the package type and the brands are different in the two products that were stitched together. In FIG. 23 the size of the bottles (package type) and the color (brand) is different (the contents of the bottles in the LEFT image is red, while the contents of the bottles in the FRONT and BACK images are yellow). The machine learning algorithm was most confident that the product was a package type of 28 OZ GAT_FRC_STW (from the LEFT image) causing an error of an extra inferred product in step 416 of FIG. 22. There will also be a missing product detected in step 418 of FIG. 22. The multiple face view logic will then correct an error consisting both of an extra inferred product and a missing product from the pick list. If the pick list is missing 20 OZ_WM_PL_1_24 Package Type (from the FRONT and BACK images of FIG. 23) that we inferred in a lesser confident package face, then we will look at the missing brands on the picklist for the package type. Out of the missing brands for the package type we will see which of those brands the machine learning has the highest percent confidence for and select that missing SKU in step 422 of FIG. 22 and make a correction with the extra inferred one in step 424.

### 2) Indistinguishable SKU Sets

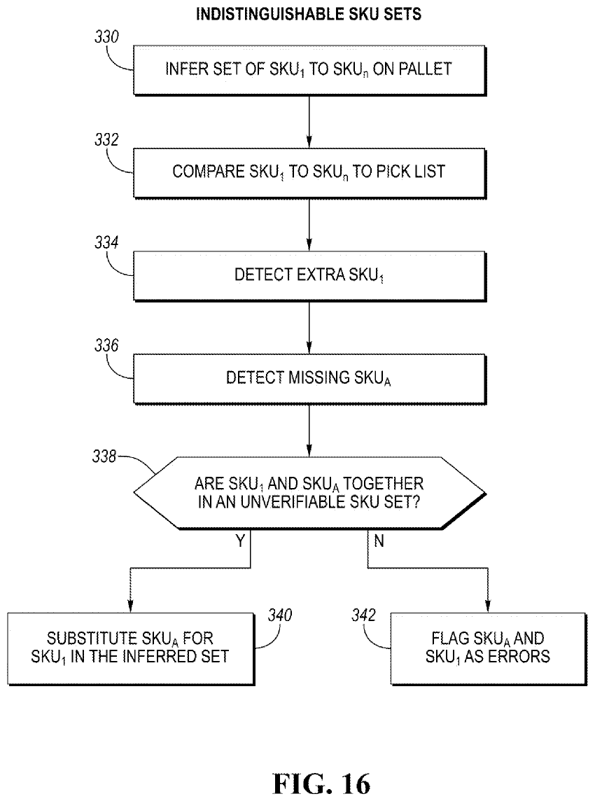

The inference sometimes has a difficult time distinguishing between particular sets of two or more SKUs. A flowchart regarding the handling of indistinguishable SKU sets is shown in FIG. 16.

For example, as shown in FIGS. 13 and 14, the end package face of a 24 pack of Aquafina water looks identical to the end package face of the 32 pack of Aquafina. Based on how the product is packed in the pallet, sometimes the side package face of the Aquafina package can be hidden and so the inference has a 50% chance of inferring correctly before this adjustment. The two SKUs in this set are indistinguishable. It is known that there is one of the SKUs in the set but sometimes the difference between the SKUs cannot be confidently distinguished know which one is there. These similar SKUs where the inference often mixes up between another or multiple SKUs are added to a SKU Set. The algorithm of FIG. 16 will adjust the inferred results between this SKU set based upon the pick list. If the pallet is inferred to have an extra 24 pack of Aquafina and is also missing a 32 pack of Aquafina then an adjustment is made to the inferred SKUs so that an error is not reported. The algorithm essentially balances the extra and missing quantities between the SKUs in the set to try to correct for what is very likely not a picking error.

Referring to FIG. 16, in step 330, SKUs for all the items on the pallet (for example) are inferred according to any of the methods described herein. In step 332, the inferred SKUs are compared to the pick list. In that comparison, in step 334 an extra SKU₁ is detected on the pallet and in step 336 a missing SKU_{A} is determined to be on the pick list but missing from the pallet. In step 338, it is determined whether SKU₁ and SKU_{A} are associated with one another in an “indistinguishable sku set.” If so, then SKU_{A} is substituted for SKU₁ in the inferred set in step 340, and no error is flagged, but the SKU_{A} may be flagged as “unconfirmed.” If SKU_{A} and SKU₁ are not in an indistinguishable sku set, then both are flagged as errors, e.g. “extra SKU_{A}” and “missing SKU₁” in step 342.

Another example of an Indistinguishable SKU set is the 700 ml Lifewater product, which presently looks identical to the 1 L Lifewater product with only being slightly bigger. The size is also dependent on the placement on the pallet and product further away from the camera appear smaller. These SKUs are added as an indistinguishable SKU set so that adjustments can be made so that too many false errors are not reported.

If an inferred result is updated based on the indistinguishable SKU set logic and the quantity of that SKU now matches the quantity on the pick list then a property is set for that SKU to indicate that the system cannot confirm that SKU. No error is flagged, but the SKU is labeled “unconfirmed.”

It may be a time-consuming process to identify all the required SKU Sets. Additionally, different SKUs sets need to be added and removed each time the models are trained. Further, as the active learning tool is used, some SKU Sets are no longer needed. Therefore, a SKU Set generation tool is provided that reviews the labeled pallets and automatically creates the SKU Sets when the machine learning incorrectly identifies a SKU.

The following process scales creating the best SKU sets:

Manual Detect—Every time that a new SKU set is discovered manually then the pallet is labeled and the pallet is stored into a location used to generate SKU sets.

Discover best SKU sets from Virtual Pallets—However, it takes a long time to manually label pallets. Manually labeling pallet images is also prone to errors. Therefore, thousands of virtual pallets are built with labeled images that used the tool to find all the SKUs that the inference gets mixed up. In other words, virtual pallets are generated with images of known SKUs and then those virtual pallet images are analyzed using the machine learning models as described above. It is determined which SKUs are often confused with one another by the system based upon the image having a known SKU but being inferred to have a different SKU. If that happens at a high enough rate, then those SKUs (two or more) are determined to be a SKU set. Indistinguishable SKU sets are generated automatically with those SKUs.

### 3) Low Confidence Brand Override

In an implemented embodiment, the package type model is more accurate than the brand models. If the package type expected from the pick list is inferred, then any brand error should not be reported unless there is sufficient confidence that there is a brand error. If the inferred package type matches the package type expected from the pick list, then the inferred brand will be overridden based on the expected brand from the pick list if the brand confidence of the inferred brand is less than the threshold.

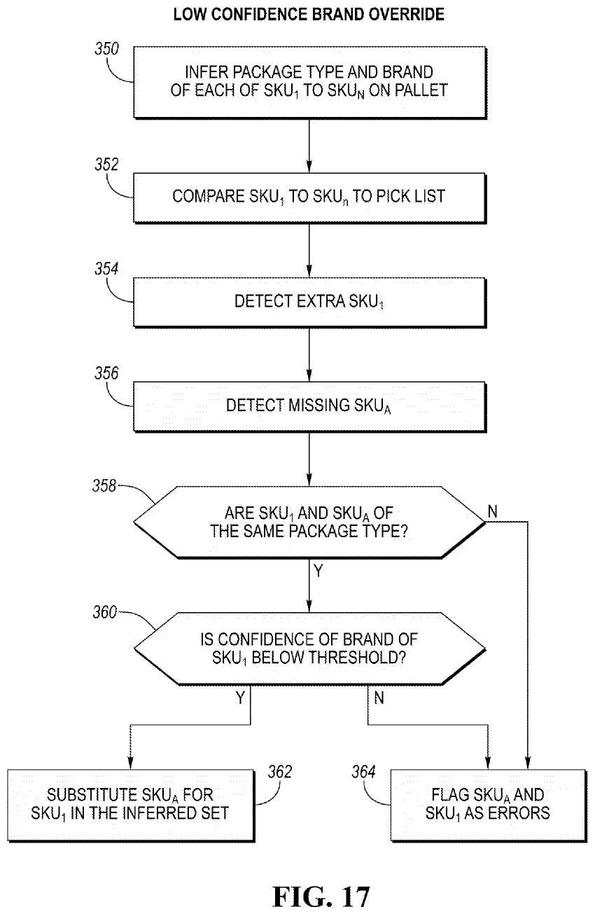

A sample flowchart for handling the low confidence brand override is shown in FIG. 17. In step 350, the SKUs for all the items on the pallet (for example) are inferred according to any of the methods described herein. In step 352, the inferred SKUs are compared to the pick list. In that comparison, in step 352 an extra SKU₁ is detected on the pallet and in step 354 a missing SKU_{A} is determined to be on the pick list but missing from the pallet. In step 358, it is determined whether the extra inferred SKU₁ and the missing expected SKU_{A} are of the same package type. If not, then the extra inferred SKU₁ and the missing expected SKU_{A} are flagged as errors in step 364. If they are determined to be of the same package type in step 358, then in step 360, it is determined whether the confidence in the inferred brand of SKU₁ is below the threshold. If so, then SKU_{A} is substituted for SKU₁ in the inferred set in step 362, and no error is flagged, but the SKU_{A} may be flagged as “unconfirmed.” If the confidence of the inferred brand of SKU₁ is not below the threshold, then both are flagged as errors, e.g. “extra SKU_{A}” and “missing SKU₁” in step 364.

### 4) Unverifiable Package Type Set

Optionally, the low confidence threshold can be set based on the inferred package type, such that different package types have different low confidence thresholds. Some package types are unbranded cardboard boxes where it is impossible to infer the brand better than a guess. The threshold for these package types can be set to always override the brand inference with the expected brand from the pick list. In other words, if the inferred package type is unbranded cardboard box, and if the quantity of inferred unbranded cardboard boxes matches the expected quantity (from the pick list), then no error will be flagged, but they will be marked “unconfirmed.”

Any of the results from the inference that are updated and also match the quantity on the pick list are set to have a “cannot confirm” property (rather than “error”) so that the QA person knows that brand was unable to be confirmed.

If one or more of an inferred SKU is updated based upon the pick list, but not in the correct quantity expected from the pick list, then there will still be a confirmed error.

### 5) Unverifiable SKU

SKUs that the system is poor at identifying are marked as unverifiable in the database. This list should be kept really small as the logic can have negative repercussions as well.

If a SKU that is marked “unverifiable” in the database or the SKU is on the pick list but missing from the inferred results while there is at least one SKU as extra in the inferred results then the least confident extra SKU is overridden and renamed with the expected unverifiable SKU from the pick list. The SKU will still have an error if the quantity is short but if the inferred quantity matches the pick list quantity then the SKU is set to “cannot confirm” but not an error.

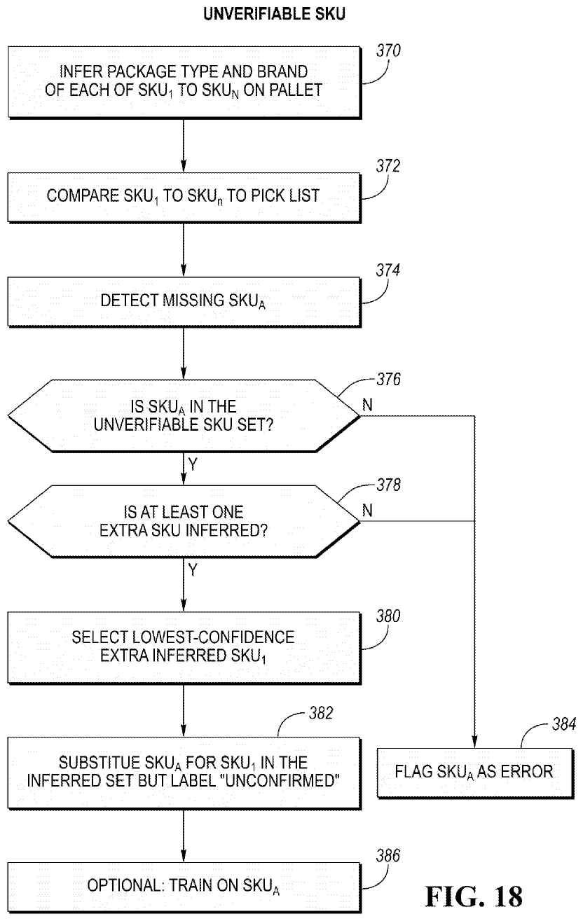

A sample flowchart for handling unverifiable SKUs is shown in FIG. 18. In step 370, the SKUs for all the items on the pallet (for example) are inferred according to any of the methods described herein. In step 372, the inferred SKUs are compared to the pick list. In that comparison, in step 374 a missing SKU_{A} is determined to be on the pick list but missing from the pallet.

In step 376 it is determined whether the missing SKU_{A} is indicated as an “unverifiable SKU.” If not, then the missing SKU_{A} is indicated as an error in step 384. If it is, then in step 378 it is determined if there is at least one extra SKU inferred. If not, then an error is indicated in step 384. If there is at least one extra SKU inferred, then in step 380 the lowest-confidence inferred extra SKU₁ is selected from the extra inferred SKU(s). In step 382, the missing expected SKU_{A} is substituted for the lowest-confidence inferred SKU₁ in the inferred set of SKUs, marked as “unconfirmed,” but not as an error.

One good way to leverage this functionality is for a new SKU that has not yet been trained in the models. The new SKU can be marked “unverifiable” in the database and/or the models. If the “missing SKU_{A}” is the new product and if the package detector model is able to detect the presence of the product without training then it will still get the case count match with the pick list. An extra inferred SKU₁ will be overridden with the new SKU_{A}. The unverifiable SKU logic will show that SKU_{A} as “cannot confirm,” but not show a false error. All of this can occur before any machine learning training of that new SKU.

Optionally, in step 386, the images for a new SKU_{A} can be used to train the machine learning models so that the new SKU_{A} could be recognized in the future. Optionally, these images for the new SKU_{A} would not be used to train the machine learning model until confirmed by a human.

### 6) Single Face View Heuristic

Most of the time the stitching algorithm can connect two or more package faces together of the same item. The inference is improved when we have multiple package faces because the highest confident package type and highest confident brand are used to get the most confident package. Heuristic logic is also used in the multiple face view algorithm to make additional corrections.

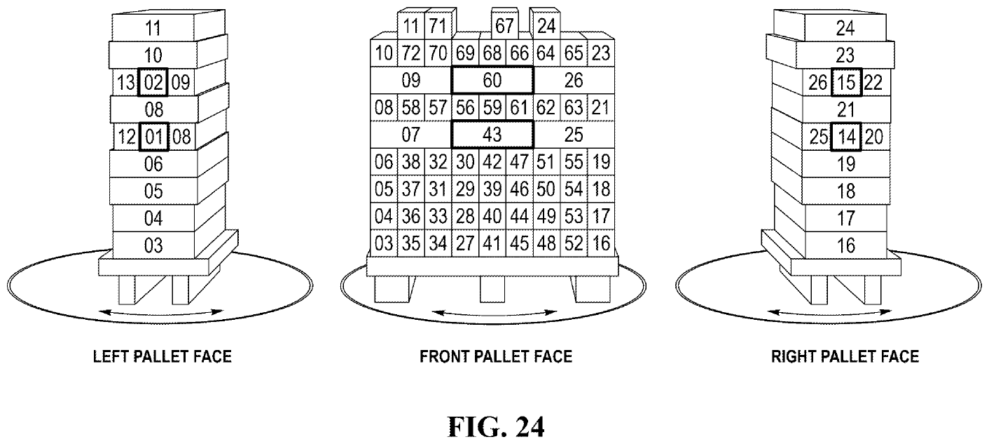

The system is more likely to be wrong when we only have one package face to work with. The picker can place a package on the pallet in a position where only one package face is visible. FIG. 24 shows six packages outlined in bold that only have a single face view visible.

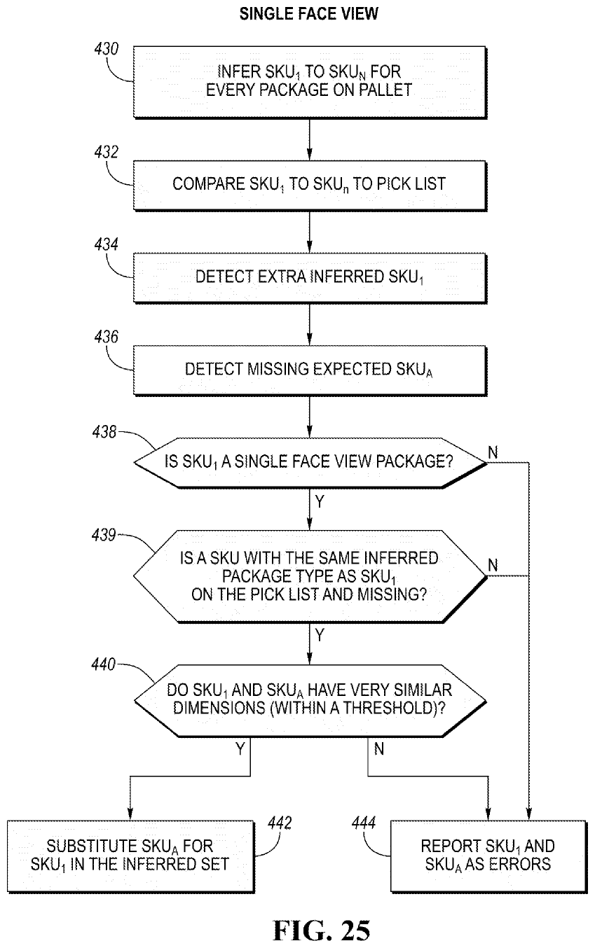

Referring to FIG. 25, in step 430, SKUs for every package on the pallet are inferred (according to methods described herein). In step 432, the inferred SKUs are compared to the expected SKUs on the pick list. In step 434, an extra SKU₁ is inferred. In step 436, a missing expected SKU_{A} is detected. If in step 438 the extra SKU₁ is determined to be a single face view package (i.e. only one package face was obtained and/or should have been obtained based upon placement and dimensions).

If the inferred package type of a single face view package is not on the pick list, then we look at other missing SKU on the pick list with dimensions like the inferred one. In step 439, if a package type missing on the pick list is a has a very similar dimension of length and height of the extra inferred package type as determined in step 440, then the correction is made in step 442 to substitute the missing SKU for the extra inferred SKU. If there is more than one missing SKU on the pick list then the one with the greatest brand confidence will be used for the correction.

### 7) SKU with Unverifiable Quantity

The quantity of some SKUs on the top of the pallet cannot be determined from the images. The pallet weight is used to help determine the SKU quantity.

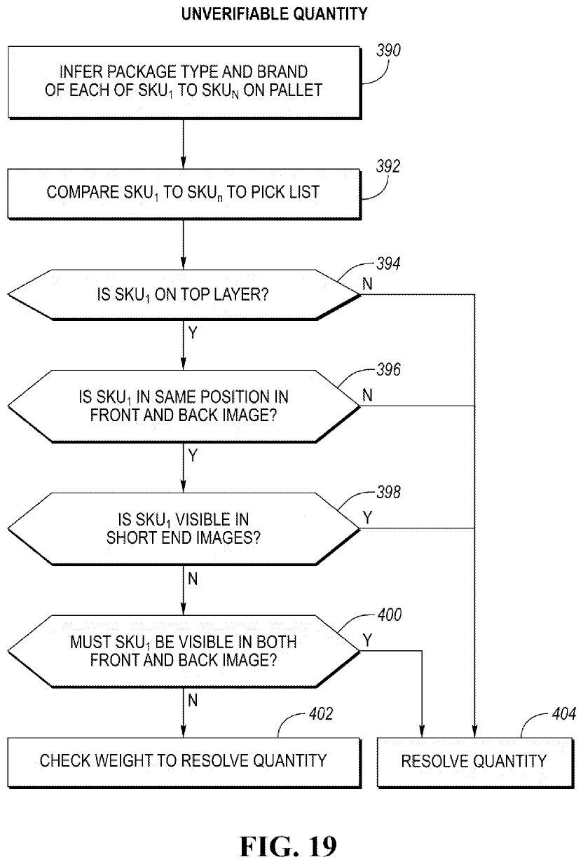

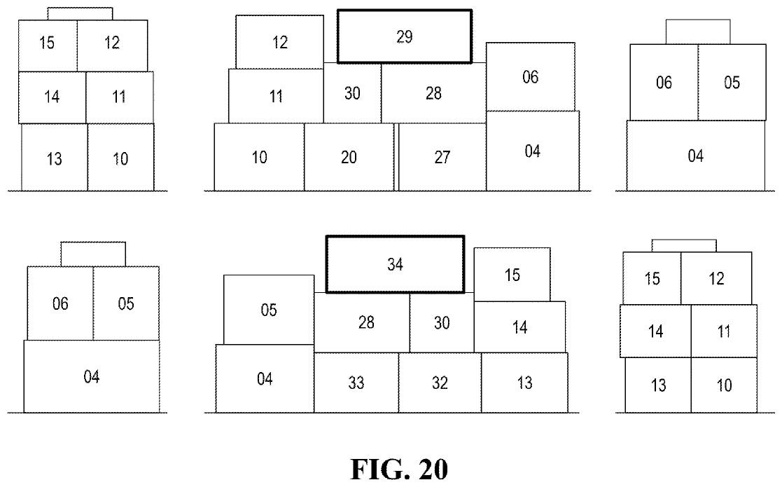

A sample flowchart for a SKU with unverifiable quantity is shown in FIG. 19 with reference to the images in FIG. 20. It must be determined if these images of SKU₁ (package faces 29 and 34) are of the same product or if there are two such products of the same SKU next to one another. As shown in FIG. 20, the product was not recognized by the machine learning model on the short sides (although we can see it in the figure), which would have resolved the ambiguity (there is only one).

In step 390, the SKUs for all the items on the pallet (for example) are inferred according to any of the methods described herein. In step 392, the inferred SKUs are compared to the pick list. In step 394 it is determined if SKU₁ (package faces 29 and 34) is on the top layer of the stack of products in the images. If not, the quantity is resolved in step 404 (i.e. there are two). If it is on the top layer, then it is determined in step 396 if SKU₁ appears in the same mirror image X coordinate position in the front and back images mirror image (within a tolerance threshold). If it is not, the quantity is resolved in step 404 (i.e. there are two).

In step 398, it is determined if SKU₁ is visible on a perpendicular side (here, the left or right end) image. If so, the quantity would be resolvable in one of the perpendicular images in step 404 because the perpendicular image would show the quantity (e.g. one versus two).

If the SKU₁ was not recognized in a perpendicular image, then it is determined in step 400 if the inferred SKU₁ has the property (e.g. dimensionally and orientationally) that it must be visible on both the front and the back pallet face. If it must, then quantity is resolved in step 404 (e.g., there is one). For example, for a product having a shorter side and a longer side, it is determined whether the shorter side or the longer side is facing the front and/or back pallet faces. If the shorter side is facing the front and/or back pallet faces, and if the longer side dimension exceeds a threshold (e.g. 10.5 inches for a half-pallet), then it is determined that the same SKU1 is visible in both the front and back pallet faces and quantity is resolved as one in step 404. The total determined quantity (i.e. including any others stacked on the pallet) is then compared to the pick list.

On the other hand, if the longer side is facing the front and/or back pallet face (as in the illustrated example), and if the shorter side is less than the threshold, then it is determined that it is possible that there are two such SKUs side-by-side and that it is possible that the system is seeing one on the front pallet face and different one on the back pallet face and the system proceeds to step 402. In step 402, weight is used to determine whether there is one or two. The weight of the plurality of products and the pallet can be compared to an expected weight of the plurality of products from the pick list (and/or the other verified SKUs) and the pallet to determine if the total weight suggests that there are two such SKUs or one such SKU. The determined quantity is then compared to the pick list.

It should also be recognized that the particular SKU may have two sides that are both greater than or both less than the threshold. If both are greater, the quantity is resolved as one in step 404. If both are less, then quantity is determined by weight in step 402.

It should also be noted that on all layers except for the top layer on the pallet, if dimensionally and orientationally possible, it is presumed that there are two items of SKU₁.

Sometimes the multiple face view is needed to correct stitching errors of missing product. This can occur because of holes and other factors. This can correct a stitching error where the case count shows a missing product, and two products were stitched together reducing the count.

Unverifiable quantity logic is added to the multiple face view. If the highest inferred package face is on the pallet 22, but the lesser inferred package face is missing then also the missing product should be corrected too. The multiple face view can increase the case count on the pallet by counting both the highest confident package face and the lesser confident different package type package face.

Sometimes there could be more than one missing product on the pick list with a package type of the lesser confident package type from the multiple face view inference. For this case the brand inference is used to match to the best missing one from the pick list.

Brand is used to block the addition of additional products based on a threshold but to ignore the threshold if the missing SKU has an underperforming brand.

The weight checksum is used to block the addition of a product when the weight does not make sense.

### Weight Checksum

There are many heuristics that can make corrections between package types inferred and ones that are missing from the pick list:

Indistinguishable SKU sets

Override multiple face view

Override Single face view

Unverifiable Quantity

SKUs of different brands can have different weights too. In one implementation, the system would only allow overrides by the heuristic algorithms if it makes sense from a weight perspective.

The heuristic is allowed to make the override assuming any of the following is true:

1) Actual pallet weight (from the scale) and expected pallet weight is in tolerance. The expected weight is the sum of pallet weight and the weight from all of the product. The tolerance is scaled based on the weight of the pallet so that the heaver pallets with more weight have a greater tolerance, e.g. the tolerance could be a percentage.

2) Is the inferred weight of the pallet in the inferred tolerance. The system sums up the weight from all the inferred product and adds in the weight of the pallet. If the inferred weight minus the expected weight is close to 0 and within a tolerance, then this indicates that the inference is close to being correct.

3) If the inferred pallet weight after making the correction with the extra and missing product is closer to the goal weight. The goal weight is the expected weight when the actual weight and expected weight is in tolerance. The goal weight is the actual scale weight when we are out of tolerance.

4) If the difference of weight is in a negligible weight difference threshold then the override is allowed. One example of when this rule is needed is for 24 packs can be grouped together in 4 groups of 6 in a tray or all 24 in a tray. They both pretty much weigh the same (they can visually look the same too).

If all the above conditions are false, then the override correction from the heuristic is blocked.

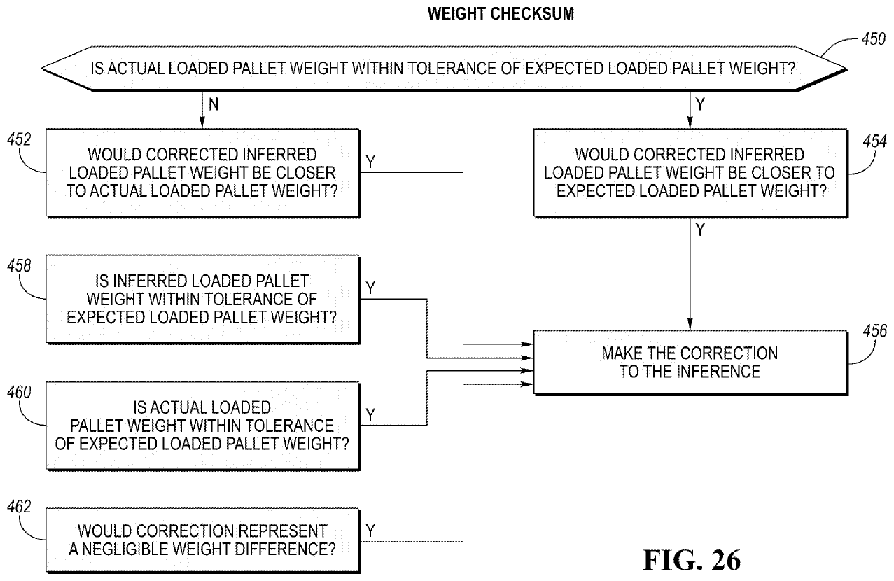

A sample implementation of this is shown in FIG. 26. In step 450, it is determined if the actual loaded pallet weight (e.g. from the sensors under the turntable) is within the tolerance of the expected loaded pallet weight (i.e. the known, expected weight of each of the SKUs on the pick list plus the expected weight of the pallet itself). If so, the correction (from one of the above methods) to the inferred list of SKUs is made in step 456 only if the correction to the inferred loaded pallet weight would bring the weight closer to the expected loaded pallet weight as determined in step 454. Otherwise, the correction is made in step 456 only if the correction would bring the inferred loaded pallet weight closer to the actual loaded pallet weight as determined in step 452.

Additionally, if the inferred loaded pallet weight is determined in step 458 to be within a tolerance threshold of the expected loaded pallet weight, then the correction is made in step 456.

If the actual loaded pallet weight is determined in step 460 to be within a tolerance threshold of the expected loaded pallet weight, then the correction is made in step 456.

Additionally, if the correction is determined in step 462 to represent a negligible weight difference (e.g. if the difference in weight between the two SKUs being corrected (i.e. swapped) is negligible, such as less than or equal to 0.2 lbs., then the correction is made in step 456.

The number of false errors reported is reduced with a weight heuristic. The weight heuristic is particularly useful for removing false inferred counts like seeing the tops of the package as an extra count or detecting product beside the pallet in the background that is not part of the pallet.

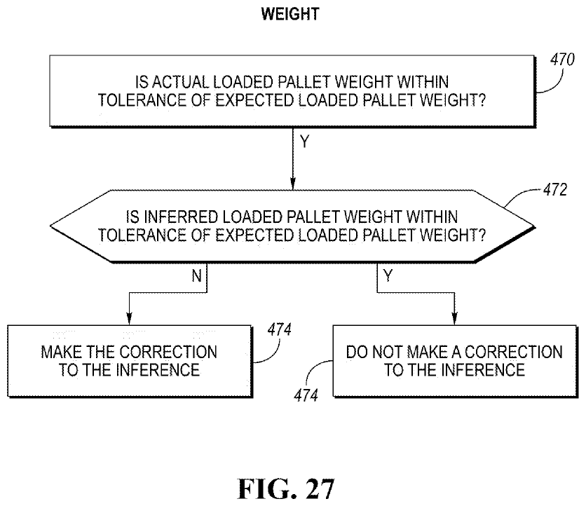

Referring to FIG. 27, the weight heuristic is run to remove false errors when both of the following are true:

1) In step 470, it is determined that the actual pallet weight (from the scale) and expected pallet weight is in tolerance. The expected weight is the sum of pallet weight and the weight from all the product. The tolerance may be scaled based on the weight of the pallet so that the heaver pallets with more weight have a greater tolerance.

2) In step 472, it is determined if the weight summed up from the products in the inference plus the pallet weight and the expected pallet weight is in a tolerance. (The tolerance can be adjusted to tune the heuristic to run more or less often.) If so, then no correction is made in step 474. If not, then the correction is made in step 476.

The premise around the weight heuristic is that if the actual weight is close to the expected weight then the pallet is likely to be picked correctly. If the inferred weight is then out of alignment with the expected weight while the actual weight from the scale is in alignment, then the inference likely has a false error.

In step 318 of FIG. 10, the system can learn from itself and improve over time unsupervised without human help through active learning. Often time, errors are automatically corrected through stitching. If the pallet inference generates the expected results as compared to the pick list SKUs and quantities then it is very likely that the correct product is on the pallet. The pallet face images can be labeled for machine learning training based on the object detector results and brand classification results and stitching algorithm corrections.

The stitching algorithm automatically makes the following types of corrections:

1. Package type override—If the package type confidence from one package face is more confident than another package face on the same item then the highest confidence package type is used.

2. Brand override—If the brand confidence from one package face is more confident than another package face on the same item then the highest confidence brand is used.

3. Holes—Once a package face is detected for a pallet face, then the stitching algorithm understands the other pallet faces that the package face should be visible on. Sometimes the package face object detector does not detect the package face on other views of the pallet face. The geometry of the package and the stitching algorithm can be used to automatically label where the package face is in the pallet face, thus reducing the occurrence of “holes.”

4. Ghosts—Sometimes the machine learning detects items that are not on the pallet. This most often occurs on the short side views of the pallet where there is a stair step of product visible and the images of two or more partial products are combined. The stitching algorithm determines based on the geometry of the pallet that those images are not products and labels them as ghosts. The ghosts are excised from the pallet inference.

There are some errors that stitching cannot fix and a human is needed to label the pallet faces with the error. The results from the package face object detector, brand classifier and stitching algorithms are leveraged to feed a tool for a human to help out by making quick corrections. The normal labeling tools involve much more effort and much more expert knowledgeable humans to label and draw bounding boxes around objects that they want to detect.

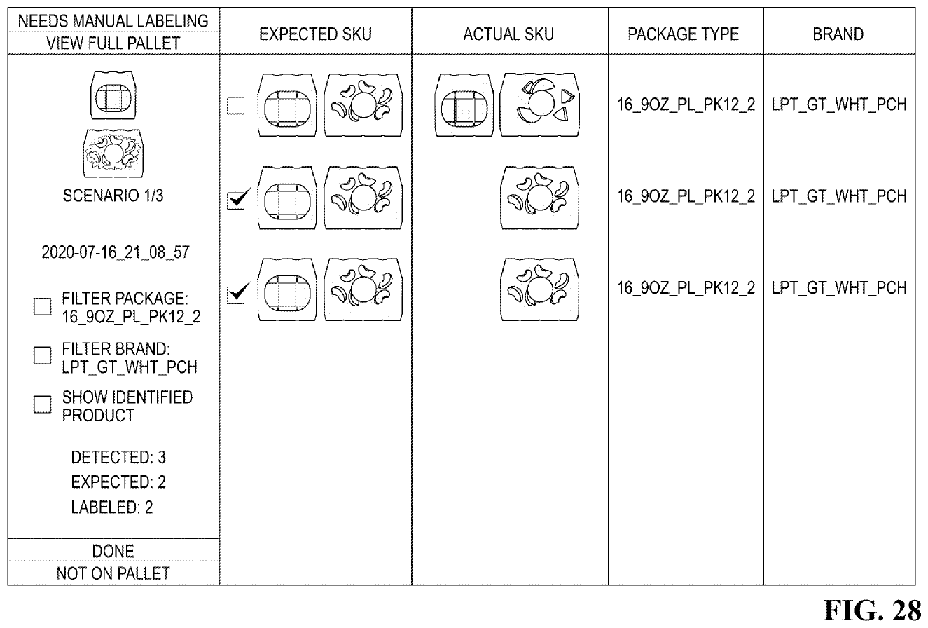

The image of the supervised labeling tool in FIG. 28 shows the innovative user interface for how labels with errors are fixed. The tool leverages stitching so that all of the package face images for a package are grouped together to make classifying by a human easier.

The tool corrects the brand and package type labels for all of the packages (items) on one pallet at a time across all four pallet face images. Packages are labeled and not SKUs to handle the scenarios where some SKUs have more than one package per case. Each package is loose and requires a bounding boxes and labels for the package type across the four pallet faces. These bounding boxes and labels can be used for package face detection model training and the labeling tool for brand training then segments the images at the bounding box coordinates and names the images based on the brand for brand training.

The error scenarios on each pallet are sorted so that errors where more package quantity is detected than expected are resolved first. These corrections provide the likely possibilities for the later scenarios where less package quantity is detected and it is necessary to identify the additional packages to add.

The tool also allows one to see all the detected product on the pallet and filter the product by the inferred package type and brand to help with labeling. The idea is that a non Subject Matter Expert (SME) can quickly make the bulk of corrections using this tool.

The alternative approach of using a standard open source tool would take a SME who understands the product a ton of additional time to manually make the corrections.

FIG. 28 shows an example of an error scenario where more is detected than was expected of a particular SKU. There is a column listing the inferred package type, a column listing the inferred brand, a column of images of the “expected SKU” (i.e. previously stored images for the SKU that is selected based upon the inferred package type and inferred brand), and a column of the actual package faces (“Actual SKU”) from which the package type and brand were inferred. In other words, based upon what was inferred, the images in the “expected SKU” column should look the same as the images in “actual SKU” column, if the SKUs were inferred correctly.

As indicated in the first column, two packages of the SKU (16.9 oz 12 pk Lipton Green Tea white peach flavor) were expected. The QA person compares the “expected SKU” images to the adjacent “actual SKU” images and marks with a checkmark the correct two. Three were detected so only two of the three packages should be confirmed with a checkmark. The expected SKU images may come from previously labeled training images.

The expected images are shown next to the actual images so that the QA person can spot the differences. The QA person will notice that there are white peaches on the bottom two sets of images like the training images and the top set of actual images has watermelons. The QA person will uncheck the top watermelon because it has the wrong label. The unchecked watermelon image becomes a candidate for a later scenario where less is detected than was expected.

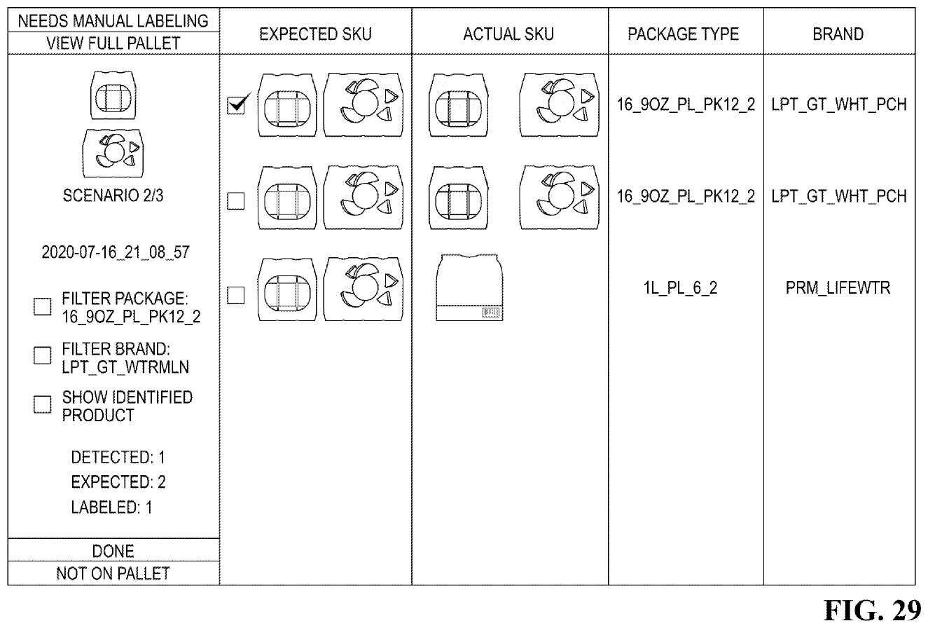

FIG. 29 also shows the supervised labeling tool. In this error scenario one was detected but two were expected. The watermelon package that was removed from the previous label is shown to be a candidate for this scenario. The QA person will see that the package type and brand look the same for the first two groups of images and will check both of them.

Behind the scenes the tool will update the labels across the four pallet faces for each view that the package face is present.

Hovering over a package face image will pop-up a view of all of the pallet faces where that package is visible with bounding boxes around that package. This will help the QA person better understand what they are looking at.

The QA person can adjust the bounding boxes that were originally created automatically by the machine learning package detect. The QA person can also add or remove bounding boxes for that package.

As indicated above, it is currently preferred in the implemented embodiment that the packaging type is determined first and is used to limit the possible brand options (e.g. by selecting one of the plurality of brand models 231). However, alternatively, the branding could be determined and used to narrow the possible packaging options to be identified. Alternatively, the branding and packaging could be determined independently and cross-referenced afterward for verification. In any method, if one technique leads to an identification with more confidence, that result could take precedence over a contrary identification. For example, if the branding is determined with low confidence and the packaging is determined with high confidence, and the identified branding is not available in the identified packaging, the identified packaging is used and the next most likely branding that is available in the identified packaging is then used.

After individual items 20 are identified on each of the four sides of the loaded pallet 22, based upon the known dimensions of the items 20 and pallet 22 duplicates are removed, i.e. it is determined which items are visible from more than one side and appear in more than one image. If some items are identified with less confidence from one side, but appear in another image where they are identified with more confidence, the identification with more confidence is used.

For example, if the pallet 22 is a half pallet, its dimensions would be approximately 40 to approximately 48 inches by approximately 20 to approximately 24 inches, including the metric 800 mm×600 mm Standard size beverage crates, beverage cartons, and wrapped corrugated trays would all be visible from at least one side, most would be visible from at least two sides, and some would be visible on three sides.

If the pallet 22 is a full-size pallet (e.g. approximately 48 inches by approximately 40 inches, or 800 mm by 1200 mm), most products would be visible from one or two sides, but there may be some products that are not visible from any of the sides. The dimensions and weight of the hidden products can be determined as a rough comparison against the pick list. Optionally, stored images (from the SKU files) of SKUs not matched with visible products can be displayed to the user, who could verify the presence of the hidden products manually.

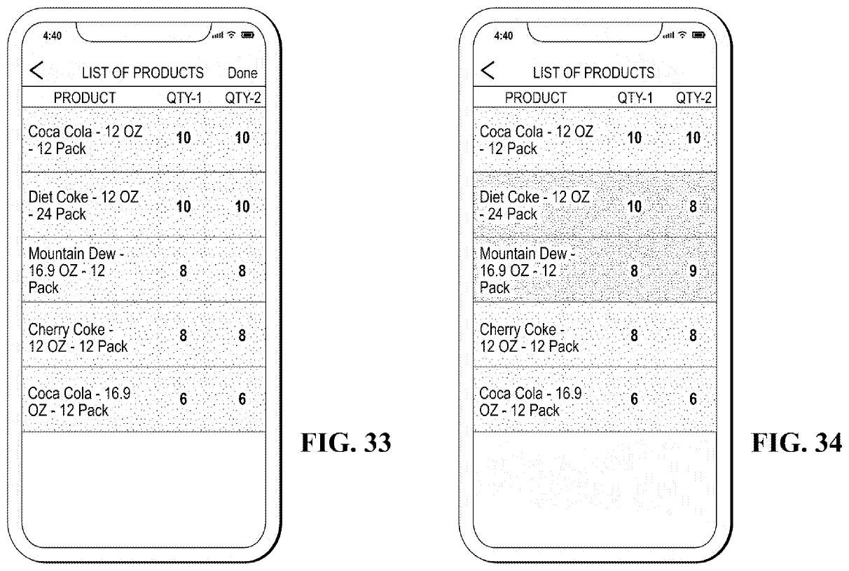

The computer vision-generated sku count for that specific pallet 22 is compared against the pick list 64 to ensure the pallet 22 is built correctly in step 162 of FIG. 2. This may be done prior to the loaded pallet 22 being wrapped thus preventing unwrapping of the pallet 22 to audit and correct. If the built pallet 22 does not match the pick list 64 (step 162), the missing or wrong SKUs are indicated to the worker (step 164), e.g. via a display (e.g. FIG. 33). Then the worker can correct the items 20 on the pallet 22 (step 166) and reinitiate the validation (i.e. initiate new images in step 156).

If the loaded pallet 22 is confirmed, positive feedback is given to the worker (e.g. FIG. 34), who then continues wrapping the loaded pallet 22 (step 168). Additional images may be taken of the loaded pallet 22 after wrapping. For example, four image may be taken of the loaded pallet before wrapping, and four more images of the loaded pallet 22 may be taken after wrapping. All images are stored locally and sent to the server 14. The worker then moves the validated loaded pallet 22 to the loading station 34 (step 170)

After the loaded pallet 22 has been validated, it is moved to a loading station 34 (FIG. 1). At the loading station 34, the distribution center computer 26 ensures that the loaded pallets 22, as identified by each pallet id, are loaded onto the correct trucks 18 in the correct order. For example, pallets 22 that are to be delivered at the end of the route are loaded first.

Referring to FIG. 1, the loaded truck 18 carries a hand truck or pallet sled 24, for moving the loaded pallets 22 off of the truck 18 and into the stores 16 (FIG. 2, step 172). The driver has a mobile device 50 which receives an optimized route from the distribution center computer 26 or central server 14. The driver follows the route to each of the plurality of stores 16 for which the truck 18 contains loaded pallets 22.

At each store 16 the driver's mobile device 50 indicates which of the loaded pallets 22 (based upon their pallet ids) are to be delivered to the store 16 (as verified by gps on the mobile device 50). The driver verifies the correct pallet(s) for that location with the mobile device 50 that checks the pallet id (rfid, barcode, etc). The driver moves the loaded pallet(s) 22 into the store 16 with the pallet sled 24.

At each store, the driver may optionally image the loaded pallets with the mobile device 50 and send the images to the central server 14 to perform an additional verification. More preferably, the store worker has gained trust in the overall system 10 and simply confirms that the loaded pallet 22 has been delivered to the store 16, without taking the time to go SKU by SKU and compare each to the list that he ordered and without any revalidation/imaging by the driver. In that way, the driver can immediately begin unloading the products 20 from the pallet 22 and placing them on shelves 54 or in coolers 56, as appropriate. This greatly reduces the time of delivery for the driver.

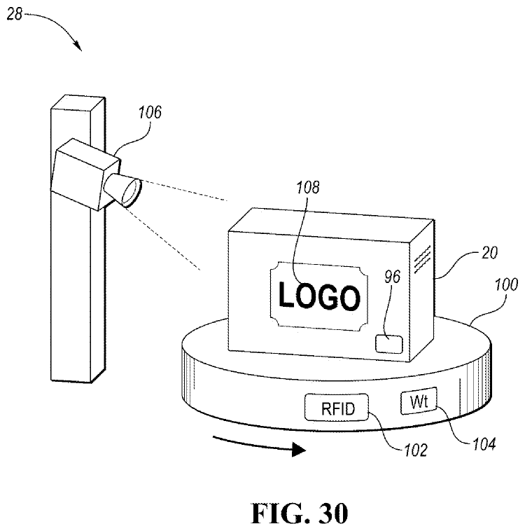

FIG. 30 shows a sample training station 28 including a turntable 100 onto which a new product 20 (e.g. for a new SKU or new variation of an existing SKU) can be placed to create the machine learning models 44. The turntable 100 may include an RFID reader 102 for reading an RFID tag 96 (if present) on the product 20 and a weight sensor 104 for determining the weight of the product 20. A camera 106 takes a plurality of still images and/or video of the packaging of the product 20, including any logos 108 or any other indicia on the packaging, as the product 20 is rotated on the turntable 100. Preferably all sides of the packaging are imaged. The images, weight, RFID information are sent to the server 14 to be stored in the SKU file 44. Optionally, multiple images of the product 20 are taken at different angles and/or with different lighting. Alternatively, or additionally, the computer files with the artwork for the packaging for the product 20 (i.e. files from which the packaging is made) are sent directly to the server 14.

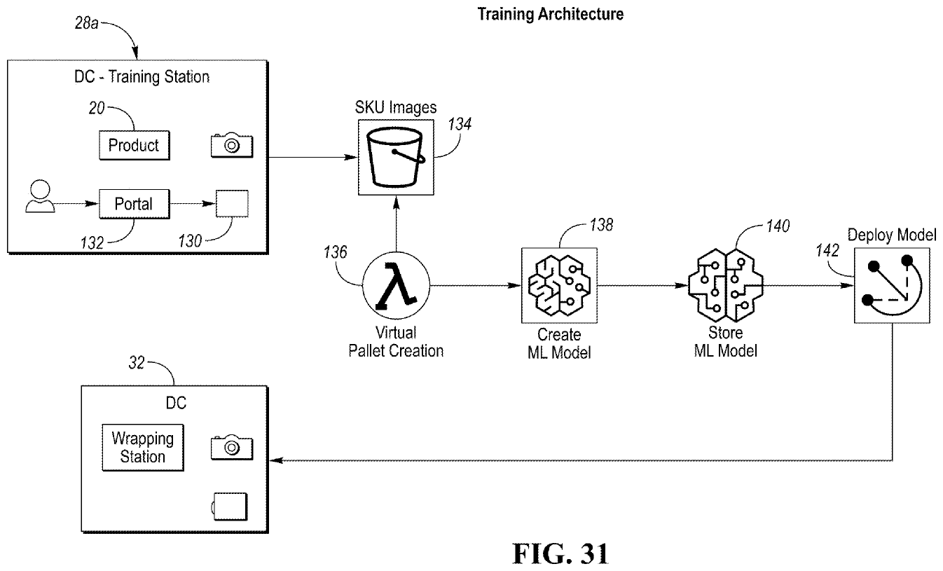

In one possible implementation of training station 28, shown in FIG. 31, cropped images of products 20 from the training station 28 are sent from the local computer 130 via a portal 132 to sku image storage 134, which may be at the server 14. Alternatively, or additionally, the computer files with the artwork for the packaging for the product 20 (i.e. files from which the packaging is made) are sent directly to the server 14. Alternatively, or additionally, actual images of the skus are taken and segmented (i.e. removing the background, leaving only the sku).

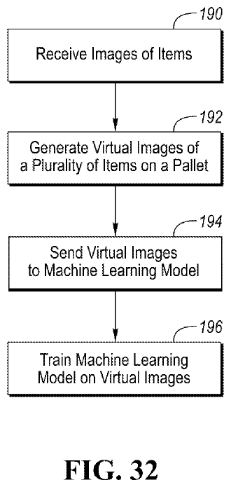

Whichever method is used to obtain the images of the items, the images of the items are received in step 190 of FIG. 32. In step 192, an API 136 takes the sku images and builds them into a plurality of virtual pallets, each of which shows how the products 20 would look on a pallet 22. The virtual pallets may include four or five layers of the product 20 on the pallet 22. Some of the virtual pallets may be made up solely of the single new product 20, and some of the virtual pallets will have a mixture of images of different products 20 on the pallet 22. The API 136 also automatically tags the locations and/or boundaries of the products 20 on the virtual pallet with the associated skus. The API creates multiple configurations of the virtual pallet to send to a machine learning model 138 in step 194 to update it with the new skus and pics.

The virtual pallets are built based upon a set of configurable rules, including, the dimensions of the pallet 22, the dimensions of the products 20, number of permitted layers (such as four, but it could be five or six), layer restrictions regarding which products can be on which layers (e.g. certain bottles can only be on the top layer), etc. The image of each virtual pallet is sized to be a constant size (or at least within a particular range) and placed on a virtual background, such as a warehouse scene. There may be a plurality of available virtual backgrounds from which to randomly select.

The API creates thousands of images of randomly-selected sku images on a virtual pallet. The API uses data augmentation to create even more unique images. Either a single loaded virtual pallet image can be augmented many different ways to create more unique images, or each randomly-loaded virtual pallet can have a random set of augmentations applied. For example, the API may add random blur (random amount of blur and/or random localization of blur) to a virtual pallet image. The API may additionally introduce random noise to the virtual pallet images, such as by adding randomly-located speckles of different colors over the images of the skus and virtual pallet. The API may additionally place the skus and virtual pallet in front of random backgrounds. The API may additionally place some of the skus at random (within reasonable limits) angles relative to one another both in the plane of the image and in perspective into the image. The API may additionally introduce random transparency (random amount of transparency and/or random localized transparency), such that the random background is partially visible through the virtual loaded pallet or portions thereof. Again, the augmentations of the loaded virtual pallets are used to generate even more virtual pallet images.

The thousands of virtual pallet images are sent to the machine learning model 138 along with the bounding boxes indicating the boundaries of each product on the image and the SKU associated with each product. The virtual pallet images along with the bounding boxes and associated SKUs constitute the training data for the machine learning models.

In step 196, the machine learning model is trained in step 138 based upon the images of the virtual pallets and based upon the location, boundary, and sku tag information. The machine learning model is updated and stored in step 140. The machine learning model is deployed in step 142 and used in conjunction with the validation stations 32 (FIG. 1) and optionally with the delivery methods described above. The machine learning model 138 may also be trained based upon actual images taken in the distribution center or the stores after identification. Optionally, feedback from the workers can factor into whether the images are used, e.g. the identified images are not used until a user has had an opportunity to verify or contradict the identification.

It should be understood that each of the computers, servers or mobile devices described herein includes at least one processor and at least one non-transitory computer-readable media storing instructions that, when executed by the at least one processor, cause the computer, server, or mobile device to perform the operations described herein. The precise location where any of the operations described herein takes place is not important and some of the operations may be distributed across several different physical or virtual servers at the same or different locations.

In accordance with the provisions of the patent statutes and jurisprudence, exemplary configurations described above are considered to represent preferred embodiments of the inventions. However, it should be noted that the inventions can be practiced otherwise than as specifically illustrated and described without departing from its spirit or scope. Alphanumeric identifiers on method steps are solely for ease in reference in dependent claims and such identifiers by themselves do not signify a required sequence of performance, unless otherwise explicitly specified.

What is claimed is:

1. A computer-implemented method for creating machine learning models, including:
a) creating a plurality of brand nodes each having an associated brand, a plurality of package nodes each having an associated package and a plurality of SKU links, wherein each SKU link connects one of the plurality of brand nodes to one of the plurality of package nodes, wherein each SKU link represents a SKU having the associated brand and the associated package, wherein each of the plurality of brand nodes in a first subset of the plurality of brand nodes is connected by a first subset of the plurality of SKU links to more than one of the plurality of package nodes, and wherein each of the plurality of package nodes in a second subset of the plurality of package nodes is connected by a second subset of the plurality of SKU links to more than one of the plurality of brand nodes;
b) determining a cut line to divide the plurality of SKU links into a first machine learning model and a second machine learning model, wherein the step of determining is performed based upon reducing a number of SKU links intersected by the cut line and based upon a tendency toward an equal number of SKU links in each machine learning model defined by the cut line;
c) duplicating the SKU links intersected by the cut line in the first machine learning model and in the second machine learning model; and
d) duplicating the brand nodes and the package nodes directly connected by the SKU links intersected by the cut line in the first machine learning model and the second machine learning model.

2. The method of claim 1 further including the step of:
e) training the first machine learning model with a plurality of images of the plurality of SKUs represented by the SKU links in the first machine learning model; and
f) training the second machine learning model with a plurality of images of the plurality of SKUs represented by the SKU links in the second machine learning model.

3. The method of claim 2 wherein the cut line is a first cut line further including the step of: during said step b), determining a second cut line to further divide the plurality of SKU links into a third machine learning model, wherein the second cut line does not intersect any SKU links, the method further including the step of training the third machine learning model with a plurality of images of the plurality of SKUs represented by the SKU links in the third machine learning model.

4. The method of claim 3 wherein the brand nodes each represent a flavor of a beverage and wherein the package nodes each represent a package type containing the beverage.

5. The method of claim 4 wherein the flavors represented by the brand nodes include flavors of soft drinks and wherein the package type represented by the package nodes includes a first package type in which a certain number of cans are contained in a box.

6. A computing system for creating machine learning models including:
at least one processor; and
at least one non-transitory computer-readable media storing:
instructions that, when executed by the at least one processor, cause the computer system to perform the following operations:
a) receiving SKU information including brand and package type for each of a plurality of SKUs;
b) creating a plurality of brand nodes each having an associated brand, a plurality of package nodes each having an associated package, and a plurality of SKU links, wherein each SKU link connects one of the plurality of brand nodes to one of the plurality of package nodes, wherein each SKU link represents one of the plurality of SKUs having the associated brand and the associated package, wherein each of the plurality of brand nodes in a first subset of the plurality of brand nodes is connected by a first subset of the plurality of SKU links to more than one of the plurality of package nodes, and wherein each of the plurality of package nodes in a second subset of the plurality of package nodes is connected by a second subset of the plurality of SKU links to more than one of the plurality of brand nodes;
c) determining a cut line to divide the plurality of SKU links into a first machine learning model and a second machine learning model, wherein the step of determining is performed based upon reducing a number of SKU links intersected by the cut line and based upon a tendency toward an equal number of SKU links in each machine learning model defined by the cut line;
d) duplicating the SKU links intersected by the cut line in the first machine learning model and in the second machine learning model; and
e) duplicating the brand nodes and the package nodes directly connected by the SKU links intersected by the cut line in the first machine learning model and the second machine learning model.

7. The computing system of claim 6 wherein the operations further include:
e) training the first machine learning model with a plurality of images of the plurality of SKUs represented by the SKU links in the first machine learning model; and
f) training the second machine learning model with a plurality of images of the plurality of SKUs represented by the SKU links in the second machine learning model.

8. The computing system of claim 7 wherein the cut line is a first cut line, the operations further including the step of: during said operation b), determining a second cut line to further divide the plurality of SKU links into a third machine learning model, wherein the second cut line does not intersect any SKU links, the operations further including training the third machine learning model with a plurality of images of the plurality of SKUs represented by the SKU links in the third machine learning model.

9. The computing system of claim 8 wherein the brand nodes each represent a flavor of a beverage and wherein the package nodes each represent a package type containing the beverage.

10. The computing system of claim 9 wherein the flavors represented by the brand nodes include flavors of soft drinks and wherein the package type represented by the package nodes includes a first package type in which a certain number of cans are contained in a box.

11. A computing system for identifying SKUs in a stack of a plurality of packages of beverage containers comprising:
at least one processor; and
at least one non-transitory computer-readable media storing:
a plurality of machine learning models that have been trained with a plurality of images of packages of beverage containers; and
instructions that, when executed by the at least one processor, cause the computer system to perform the following operations:
a) receiving at least one image of the stack of the plurality of packages of beverage containers;
b) inferring a package type of each of the plurality of packages of beverage containers;
c) based upon the package type inferred for each of the plurality of packages of beverage containers, choosing at least one of the plurality of machine learning models; and
d) using the machine learning model chosen in step c) for each of the plurality of packages of beverage containers, inferring a brand of each of the plurality of packages of beverage containers based upon the at least one image.

12. The computing system of claim 11 wherein said operations further include:
e) identifying at least one inferred SKU for each of the plurality of packages of beverage containers based upon the package type inferred in step b) and the brand inferred in step d).

13. The computing system of claim 12 wherein said operations further include:
f) comparing the at least one inferred SKUs for each of the plurality of packages of beverage containers with a pick list representing a plurality of expected SKUs in an order.

14. The computing system of claim 13 wherein said operations further include:
g) identifying an extra inferred SKU;
h) identifying a missing expected SKU;
i) determining whether the extra inferred SKU and the missing expected SKU are associated with one another in a SKU set; and
j) based upon a determination in said step i) that the extra inferred SKU and the missing expected SKU are associated with one another in a SKU set, substituting the expected SKU for the inferred SKU or otherwise ignoring errors associated with steps g) and h).

15. The computing system of claim 11 wherein the at least one image includes a plurality of images from different sides of the stack of packages of beverage containers, wherein said operations further include associating portions of each of the plurality of images with one another corresponding to the same ones of the plurality of packages of beverage containers.

16. The computing system of claim 15 wherein said steps b) to d) are performed for each of the portions of each of the plurality of images.

17. The computing system of claim 16 wherein said operations further include generating a confidence level for the package type inferred for each of the portions of each of the plurality of images.

18. The computing system of claim 17 wherein said operations further include generating a confidence level for the brand inferred for each of the portions of each of the plurality of images.
